(19) United States
(12) Patent Application Publication
(10) Pub. No.: US 2026/0284659 A1
(43) Pub. Date: Sep. 24, 2026

(54) BUBBLE REMOVAL MECHANISMS IN FLUIDIC DEVICES

(71) Applicant: Singular Genomics Systems, Inc., San Diego, CA (US)

(72) Inventors: Panteleimon ATHANASIOU, Oceanside, CA (US); Sandor KOVACS, Middletown, DE (US); Kevin James CAPPA, San Diego, CA (US); Trevor Daniel VOGT, Escondido, CA (US)

(21) Appl. No.: 19/570,449

(22) Filed: Mar. 18, 2026

Related U.S. Application Data
(60) Provisional application No. 63/775,028, filed on Mar. 20, 2025.

(51) Int. Cl. B01L 3/00

(52) U.S. Cl. CPC B01L 3/502723; B01L 3/502738; B01L 2200/0684; B01L 2300/0627; B01L 2300/0829; B01L 2400/0694; B01L 2400/082

(57) ABSTRACT

Disclosed herein, inter alia, are systems and methods useful for reducing bubble formation in fluidic devices.

### CROSS-REFERENCES TO RELATED APPLICATIONS

This application claims the benefit of U.S. Provisional Application No. 63/775,028 filed Mar. 20, 2025, which is incorporated herein by reference in its entirety and for all purposes.

### BACKGROUND

Fluidic systems in medical devices such as sequencing platforms or spatial platforms are prone to bubble formation. Bubbles from upstream fluidic paths travel to areas of interest such as detection areas for optical or biochemical sensing regions. Bubbles passing through this area may become lodged/trapped or dislodged over the period of detection which can impact signal reading negatively. More specifically, in spatial biology and in situ sequencing related applications, bubbles may become trapped in regions of interest such as tissue samples or critical surfaces, creating areas of reduced or void detection, resulting in loss of data and resolution. Disclosed herein, inter alia, are solutions to these and other problems in the art.

### BRIEF SUMMARY

The aspects and embodiments described herein relate to a system configured to remove a bubble from a fluidic pathway of a spatial sequencing system. In an aspect is a method of removing a bubble from a fluidic pathway of a spatial sequencing system.

### BRIEF DESCRIPTION OF THE DRAWINGS

FIGS. 1A-1B. FIG. 1A shows a bubble trap test assemblies. FIG. 1B shows a detailed top view of bubble trap test assembly.

FIGS. 2A-2H show alternative bubble trap geometries. Straight vertical channel, no ramp (FIG. 2A). Straight vertical channel, 1.5×1 mm ramp (FIG. 2B). Straight vertical channel, 2.25×1 mm ramp (FIG. 2C). Straight vertical channel, 3×1.5 mm ramp (FIG. 2D). Offset vertical channel, 1×1 mm ramp (FIG. 2E). Offset vertical channel, 1.5×1 mm ramp (FIG. 2F). Offset vertical channel, 2.25×1 mm ramp (FIG. 2G). Offset vertical channel, 3×1.5 mm ramp (FIG. 2H).

FIGS. 3A-3H. Alternative bubble trap geometries. Ball-end bottom, 1 mm diameter trap, 60° chamfered top (FIG. 3A). Ball-end bottom, teardrop lead-in, 1 mm trap diameter, 60° chamfered top (FIG. 3B). Ball-end bottom, large teardrop lead-in, 1.5 mm trap diameter, 60° chamfered top (FIG. 3C). Ball-end bottom, 2×1 mm ball-end ramp, 1 mm trap diameter, 60° chamfered top (FIG. 3D). Ball-end bottom, interpolated ramp, 1 mm trap diameter (FIG. 3E). Ball-end bottom, 2×1 mm ball-end ramp, 1 mm trap diameter, 60° chamfered top (FIG. 3F). Ball-end bottom, no ramp, 1 mm trap diameter, 60° chamfered top (FIG. 3G). Ball-end bottom, 2×1 mm straight ramp, 1 mm trap diameter, 60° chamfered top (FIG. 3H).

FIG. 4. shows an implementation of a manifold used for reagent delivery.

FIG. 5. shows a cross sectional view of a bubble trap implementation in manifold.

FIG. 6. shows an implementation of a bubble trap in manifold used for reagent delivery.

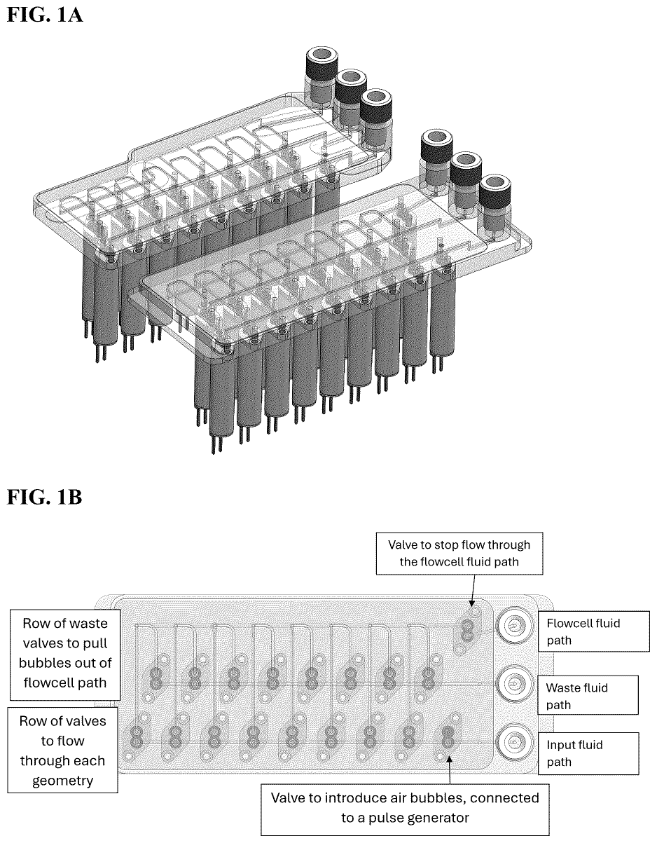

### DETAILED DESCRIPTION

The aspects and embodiments described herein relate to a system configured to remove a bubble from a fluidic pathway of a spatial sequencing system. In an aspect is a method of removing a bubble from a fluidic pathway of a spatial sequencing system.

### I. Definitions

All patents, patent applications, articles and publications mentioned herein, both supra and infra, are hereby expressly incorporated herein by reference in their entireties.

Unless defined otherwise herein, all technical and scientific terms used herein have the same meaning as commonly understood by one of ordinary skill in the art to which this disclosure belongs. Various scientific dictionaries that include the terms included herein are well known and available to those in the art. Although any methods and materials similar or equivalent to those described herein find use in the practice or testing of the disclosure, some preferred methods and materials are described. Accordingly, the terms defined immediately below are more fully described by reference to the specification as a whole. It is to be understood that this disclosure is not limited to the particular methodology, protocols, and reagents described, as these may vary, depending upon the context in which they are used by those of skill in the art. The following definitions are provided to facilitate understanding of certain terms used frequently herein and are not meant to limit the scope of the present disclosure.

As used herein, the singular terms “a”, “an”, and “the” include the plural reference unless the context clearly indicates otherwise. Reference throughout this specification to, for example, “one embodiment”, “an embodiment”, “another embodiment”, “a particular embodiment”, “a related embodiment”, “a certain embodiment”, “an additional embodiment”, or “a further embodiment” or combinations thereof means that a particular feature, structure or characteristic described in connection with the embodiment is included in at least one embodiment of the present disclosure. Thus, the appearances of the foregoing phrases in various places throughout this specification are not necessarily all referring to the same embodiment. Furthermore, the particular features, structures, or characteristics may be combined in any suitable manner in one or more embodiments.

As used herein, the term “flow cell” or “flowcell” refers to the reaction vessel in a nucleic acid sequencing device. The flow cell is typically a glass slide containing one or more fluidic channels, through which fluidic solutions (e.g., polymerases, nucleotides, air, and buffers) may traverse. In embodiments, the flow cell includes 2 or more (e.g., 4) independent channels. The flow cell is typically a glass slide containing small fluidic channels (e.g., a glass slide 75 mm×25 mm×1 mm having one or more channels), through which sequencing solutions (e.g., polymerases, nucleotides, and buffers) may traverse. Though typically glass, suitable flow cell materials may include polymeric materials, plastics, silicon, quartz (fused silica), Borofloat® glass, silica, silica-based materials, carbon, metals, an optical fiber or optical fiber bundles, sapphire, or plastic materials such as COCs and epoxies. The particular material can be selected based on properties desired for a particular use. The flow cells used in the various embodiments can include millions of individual nucleic acid clusters, e.g., about 2-8 million clusters per channel. Each of such clusters can give read lengths of at least 25-100 bases for DNA sequencing. The systems and methods herein can generate over a gigabase (one billion bases) of sequence per sequencing experiment.

As used herein, the term “fluid” or “solution” or “reagent” may be used interchangeably and includes any liquid or gas. A fluid can include, for example, air, a sequencing reaction solution (such as aqueous buffer containing enzymes, salts, and nucleotides); a wash solution (an aqueous buffer); a cleave solution (an aqueous buffer containing a cleaving agent, such as a reducing agent such as Dithiothreitol (DTT), tris(2-carboxyethyl)phosphine) (TCEP), or Tris(3-hydroxypropyl)phosphine (THPP); or a cleaning solution (a dilute bleach, dilute NaOH, dilute HCl, deionized water). The fluid can be, for example, an aqueous solution which may contain buffers (e.g., saline-sodium citrate (SSC), tris(hydroxymethyl)aminomethane or “Tris”), aqueous salts (e.g., KCl or (NH4)2SO4)), nucleotides, polymerases, cleaving agent (e.g., tri-n-butyl-phosphine, triphenyl phosphine and its sulfonated versions (i.e., tris(3-sulfophenyl)-phosphine, TPPTS), and tri(carboxyethyl)phosphine (TCEP) and its salts, cleaving agent scavenger compounds (e.g., 2′-Dithiobisethanamine or 11-Azido-3,6,9-trioxaundecane-1-amine), chelating agents (e.g., EDTA), detergents, surfactants, crowding agents, or stabilizers (e.g., PEG, Tween, BSA).

As used herein, the term “channel” refers to a passage in or on a substrate material that directs the flow of a fluid. A channel may run along the surface of a substrate, or may run through the substrate between openings in the substrate. A channel can have a cross section that is partially or fully surrounded by substrate material (e.g., a fluid impermeable substrate material). For example, a partially surrounded cross section can be a groove, trough, furrow or gutter that inhibits lateral flow of a fluid. The transverse cross section of an open channel can be, for example, U-shaped, V-shaped, curved, angular, polygonal, or hyperbolic. A channel can have a fully surrounded cross section such as a tunnel, tube, or pipe. A fully surrounded channel can have a rounded, circular, elliptical, square, rectangular, or polygonal cross section. In particular embodiments, a channel can be located in a flow cell, for example, being embedded within the flow cell. A channel in a flow cell can include one or more windows that are transparent to light in a particular region of the wavelength spectrum. In embodiments, the channel contains one or more polymers of the disclosure. In embodiments, the channel is filled by the one or more polymers, and flow through the channel (e.g., as in a sample fluid) is directed through the polymer in the channel. In embodiments, the channel contains a gel. The term “gel” in this context refers to a semi-rigid solid that is permeable to liquids and gases. Exemplary gels include, but are not limited to, those having a colloidal structure, such as agarose; polymer mesh structure, such as gelatin; or cross-linked polymer structure, such as polyacrylamide or a derivative thereof. Analytes, such as polynucleotides, can be attached to a gel or polymer material via covalent or non-covalent means. Exemplary methods and reactants for attaching nucleic acids to gels are described, for example, in US 2011/0059865 which is incorporated herein by reference. The analytes can be nucleic acids and the nucleic acids can be attached to the gel or polymer via their 3′ oxygen, 5′ oxygen, or at other locations along their length such as via a base moiety of the 3′ terminal nucleotide, a base moiety of the 5′ nucleotide, and/or one or more base moieties elsewhere in the molecule. In embodiments, the shape of the channel can include sides that are curved, linear, angled or a combination thereof. Other channel features can be linear, serpentine, rectangular, square, triangular, circular, oval, hyperbolic, or a combination thereof. The channels can have one or more branches or corners. The channels can connect two points on a substrate, one or both of which can be the edge of the substrate. The channels can be formed in the substrate material by any suitable method. For example, channels can be drilled, etched, or milled into the substrate material. Channels can be formed in the substrate material prior to bonding multiple layers together. Alternatively, or additionally, channels can be formed after bonding layers together. In an embodiment, at least one channel has a cross sectional shape of a circle, rectangle, oval, or any other shape. Preferably, the flow rates, fluid viscosities, compositions, and geometries and sizes of the channel are selected so that fluid flow is laminar. Guidance for making such design choices is readily available publicly available resources, for example Acheson, Elementary Fluid Dynamics (Clarendon Press, 1990), and from software for modeling fluidics systems, e.g. SolidWorks from Dassault Systems. In an embodiment, at least one channel has passage cross-sections in the range of tens of square microns to a few square millimeters (e.g., maximal cross-sectional dimensions of from about 500 μm to about 0.1 μm). In an embodiment, the flow rates in the range of from a few nL/sec to a hundreds of μL/sec.In an embodiment, volume capacities in are the range of from 1 μm to a few nL, e.g. 10-100 nL. In embodiments the channel is an open channel. In embodiments the channel is a closed channel.

As used herein, the term “substrate” refers to a solid support material. The substrate can be non-porous or porous. The substrate can be rigid or flexible. A nonporous substrate generally provides a seal against bulk flow of liquids or gases. Exemplary solid supports include, but are not limited to, glass and modified or functionalized glass, plastics (including acrylics, polystyrene and copolymers of styrene and other materials, polypropylene, polyethylene, polybutylene, polyurethanes, Teflon™, cyclic olefin copolymers, polyimides etc.), nylon, ceramics, resins, Zeonor, silica or silica-based materials including silicon and modified silicon, carbon, metals, inorganic glasses, optical fiber bundles, photopatternable dry film resists, UV-cured adhesives and polymers. Particularly useful solid supports for some embodiments have at least one surface located within a flow cell. The substrate may include wells. The term “surface” is intended to mean an external part or external layer of a substrate. The surface can be in contact with another material such as a gas, liquid, gel, polymer, organic polymer, second surface of a similar or different material, metal, or coat. The surface, or regions thereof, can be substantially flat. The substrate and/or the surface can have surface features such as wells, pits, channels, ridges, raised regions, pegs, posts or the like.

The term “well” refers to a discrete concave feature in a substrate having a surface opening that is completely surrounded by interstitial region(s) of the surface. Wells can have any of a variety of shapes at their opening in a surface including but not limited to round, elliptical, square, polygonal, star shaped (with any number of vertices) etc. The cross section of a well taken orthogonally with the surface can be curved, square, polygonal, hyperbolic, conical, or angular. In embodiments, the substrate includes a plurality of wells, wherein the wells containing a polymer or gel material, and the wells are separated from each other by interstitial regions on the surface, the interstitial regions segregating the gel material in each of the wells from the gel material in other wells. In embodiments, a well is capable of including some volume of liquid. The minimum or maximum volume may be selected for enhancing desired characteristics, such as throughput, resolution, analyte composition, or analyte reactivity. For example, the volume can be at least 1×10⁻³ μm³, 1×10⁻² μm³, 0.1 μm³, 1 μm³, 10 μm³, 100 μm³ or more. In embodiments, the volume can be at most 1×10⁴ μm³, 1×10³ μm³, 100 μm³, 10 μm³, 1 μm³, 0.1 μm³ or less. It will be understood that a gel material or polymer can fill all or part of the volume of a well. The volume of gel in an individual well can be greater than, less than or between the values specified above. In embodiments, a gel layer can have a depth that is at least about 10 nm, 25 nm, 50 nm, 100 nm, 500 nm, 1 μm, 10 μm, 50 μm, 100 μm, 500 μm, 1 mm, 10 mm, 100 mm or higher. In embodiments, the depth of a gel layer can be at most about 100 mm, 10 mm, 1 mm, 500 μm, 100 μm, 50 μm, 10 μm, 1 μm, 500 nm, 100 nm, 50 nm, 25 nm, 10 nm or 1 nm. Wells may have a cross-sectional dimension of less than about 250 μm, less than about 100 μm, or less than about 50 μm. In some embodiments, wells can have a volume of less than 10 μL, less than 1 μL, less than 0.1 μL, less than 10 nL, less than 1 nL, less than 0.1 nL, or less than 10 pL.

As used herein the terms “automated” and “semi-automated” mean that the operations are performed by system programming or configuration with little or no human interaction once the operations are initiated, or once processes including the operations are initiated.

It is to be understood that the phrase “fluidically connected” or “fluidly connected” may be used herein to describe connections between two or more components that place such components in fluidic communication with one another, much in the same manner that “electrically connected” may be used to describe an electrical connection between two or more components.

As used herein, the terms “sequencing”, “sequence determination”, “determining a nucleotide sequence”, and the like include determination of a partial or complete sequence information (e.g., a sequence) of a polynucleotide being sequenced, and particularly physical processes for generating such sequence information. That is, the term includes sequence comparisons, consensus sequence determination, contig assembly, fingerprinting, and like levels of information about a target polynucleotide, as well as the express identification and ordering of nucleotides in a target polynucleotide. The term also includes the determination of the identification, ordering, and locations of one, two, or three of the four types of nucleotides within a target polynucleotide. In some embodiments, a sequencing process described herein comprises contacting a template and an annealed primer with a suitable polymerase under conditions suitable for polymerase extension and/or sequencing. The sequencing methods are preferably carried out with the target polynucleotide arrayed on a solid substrate within a flow cell. In an embodiment, the sequencing is sequencing by synthesis (SBS). Briefly, SBS methods involve contacting target nucleic acids with one or more labeled nucleotides in the presence of a DNA polymerase. Optionally, the labeled nucleotides can further include a reversible termination property that terminates extension once the nucleotide has been incorporated. Thus, for embodiments that use reversible termination, a cleaving solution can be delivered to the flow cell (before or after detection occurs). Washes can be carried out between the various delivery steps. The cycle can then be repeated n times to extend the primer by n nucleotides, thereby detecting a sequence of length n. Exemplary SBS procedures and detection platforms that can be readily adapted for use with the methods of the present disclosure are described, for example, in Bentley et al., Nature 456:53-59 (2008), WO 2004/018497; and WO 2007/123744, each of which is incorporated herein by reference in its entirety. In an embodiment, sequencing is pH-based DNA sequencing. The concept of pH-based DNA sequencing, has been described in the literature, including the following references that are incorporated by reference: US2009/0026082; and Pourmand et al, Proc. Natl. Acad. Sci., 103:6466-6470 (2006) which are incorporated herein by reference in their entirety. Other sequencing procedures that use cyclic reactions can be used, such as pyrosequencing. Sequencing-by-ligation reactions are also useful including, for example, those described in Shendure et al. Science 309:1728-1732 (2005). Sequencing can include a plurality of sequencing cycles.

The term “sequencing device” means an integrated system of one or more chambers, ports, and channels that are interconnected and in fluid communication and designed for carrying out an analytical reaction or process, either alone or in cooperation with an appliance or instrument that provides support functions, such as sample introduction, fluid and/or reagent driving means, temperature control, detection systems (e.g., one or more lasers and one or more optical sensors such as a camera, objective, and lenses for detecting fluorescence), data collection and/or integration systems, for the purpose of determining the nucleic acid sequence of a template polynucleotide. Sequencing devices may further include fluidic reservoirs (e.g., bottles), valves, pressure sources, pumps, sensors, control systems, valves, pumps, and specialized functional coatings on interior walls. In embodiments, the device includes a plurality of a sequencing reagent reservoirs and a plurality of clustering reagent reservoirs. In embodiments, the clustering reagent reservoir includes amplification reagents (e.g., an aqueous buffer containing enzymes, salts, and nucleotides, denaturants, crowding agents, etc.) In embodiments, the reservoirs include sequencing reagents (such as an aqueous buffer containing enzymes, salts, and nucleotides); a wash solution (an aqueous buffer); a cleave solution (an aqueous buffer containing a cleaving agent, such as a reducing agent); or a cleaning solution (a dilute bleach solution, dilute NaOH solution, dilute HCl solution, dilute antibacterial solution, or water). The fluid of each of the reservoirs can vary. The fluid can be, for example, an aqueous solution which may contain buffers (e.g., saline-sodium citrate (SSC), tris(hydroxymethyl)aminomethane or “Tris”), aqueous salts (e.g., KCl or (NH4)2SO4)), nucleotides, polymerases, cleaving agent (e.g., tri-n-butyl-phosphine, triphenyl phosphine and its sulfonated versions (i.e., tris(3-sulfophenyl)-phosphine, TPPTS), and tri(carboxyethyl)phosphine (TCEP) and its salts, cleaving agent scavenger compounds (e.g., 2′-Dithiobisethanamine or 11-Azido-3,6,9-trioxaundecane-1-amine), chelating agents (e.g., EDTA), detergents, surfactants, crowding agents, or stabilizers (e.g., PEG, Tween, BSA). Non-limited examples of reservoirs include cartridges, pouches, vials, containers, and eppendorf tubes. In embodiments, the device is configured to perform fluorescent imaging. In embodiments, the device includes one or more light sources (e.g., one or more lasers). In embodiments, the illuminator or light source is a radiation source (i.e., an origin or generator of propagated electromagnetic energy) providing incident light to the sample. A radiation source can include an illumination source producing electromagnetic radiation in the ultraviolet (UV) range (about 200 to 390 nm), visible (VIS) range (about 390 to 770 nm), or infrared (IR) range (about 0.77 to 25 microns), or other range of the electromagnetic spectrum. In embodiments, the illuminator or light source is a lamp such as an arc lamp or quartz halogen lamp. In embodiments, the illuminator or light source is a coherent light source. In embodiments, the light source is a laser, LED (light emitting diode), a mercury or tungsten lamp, or a super-continuous diode. In embodiments, the light source provides excitation beams having a wavelength between 200 nm to 1500 nm. In embodiments, the laser provides excitation beams having a wavelength of 405 nm, 470 nm, 488 nm, 514 nm, 520 nm, 532 nm, 561 nm, 633 nm, 639 nm, 640 nm, 800 nm, 808 nm, 912 nm, 1024 nm, or 1500 nm. In embodiments, the device includes an imaging system. The imaging system capable of exciting one or more of the identifiable labels (e.g., a fluorescent label) linked to a nucleotide and thereafter obtain image data for the identifiable labels. The image data (e.g., detection data) may be analyzed by another component within the device. The imaging system may include a fluorescence spectrophotometer including an objective lens and/or a solid-state imaging device. The solid-state imaging device may include a charge coupled device (CCD) and/or a complementary metal oxide semiconductor (CMOS).

The term “port” is used in accordance with its plain ordinary meaning and refers to a designated entry or exit point on the device where fluids, gases, or other substances can be introduced into or removed from the microfluidic system. Ports are typically small and precise to accommodate the scaled-down dimensions of microfluidic channels and chambers. For example, the solid support may include an inlet port, that is, a port through which fluids (such as reagents, samples, or solvents) are introduced into the microfluidic device. The solid support may include an outlet port through which fluids exit the microfluidic device. In embodiments, the inlet and outlet ports are distinct and separate. In embodiments, the inlet port and the outlet ports are the same. As used herein, the term “inlet” or “inlet port” refers to the location on a flow cell assembly where the reagents and fluids used for methods described herein enters the flow cell. As used herein, the term “outlet” or “outlet port” refers to the location on a flow cell assembly where the reagents and fluids used for methods described herein exits the flow cell after contacting the reaction chamber containing the cell or tissue to be analyzed. “Bubble” means a gaseous bubble in a fluid. A bubble may be at least partially bounded by fluid. For example, a bubble may be completely surrounded by fluid or may be bounded by fluid and one or more surfaces of the microfluidic device (e.g., spatial sequencing system described herein).

A “fluidic device” is used in accordance with its ordinary meaning and refers to an integrated system of one or more chambers, ports, and channels that are interconnected and in fluid communication and designed for carrying out an analytical reaction or process, either alone or in cooperation with an appliance or instrument that provides support functions. Fluidic devices, such as microfluidic devices, may further include valves, pumps, and specialized functional coatings on interior walls, e.g. to prevent adsorption of sample components or reactants, facilitate reagent movement by electroosmosis, or the like. Features of a microfluidic device usually have cross-sectional dimensions of less than a few hundred square micrometers and passages typically have capillary dimensions, e.g. having maximal cross-sectional dimensions of from about 500 μm to about 0.1 μm. Microfluidics devices typically have volume capacities in the range of from 1 μm to a few nL (e.g., 10-100 nL). The term “microtube” is used in accordance with its ordinary meaning and refers to a hollow conduit capable of holding and conducting objects, liquids, or gases, typically having an internal diameter of 1 mm-10 mm. In embodiments, the internal diameter of the microtube is 1/64 inch (0.39 mm), 1/32 inch (0.79 mm), 1/16 inch (1.58 mm), ⅛ inch (3.17 mm), 5/32 inch (3.96 mm), 3/16 inch (4.76 mm), or ¼ inch (6.35 mm). Flow within a microtube is regulated by the inside diameter of the tube and the length of tubing used. Microtubes may be manufactured out of any suitable material, including, but not limited to polypropylene, polytetrafluoroethylene (PTFE) (e.g., Teflon™; Teflon™ is a registered trademark of the Chemours Company of Wilmington, Del., USA.), fluorinated ethylene propylene (FEP), polyether ether ketone (PEEK), ethylene tetrafluoroethylene (ETFE), or Tygon® thermoplastic (e.g., R-3603). Such microtubes, such as PTFE, can be chosen in order to, e.g., minimize interaction with the reagents. The diameter of the microtubes can vary between embodiments, but can be chosen based on other factors such as, for example, the desire to decrease “dead volume” or the amount of fluid left in the microtubes.

As used herein, “air” refers to the composition of gases predominating in the atmosphere of the earth. The four most plentiful gases are nitrogen (typically present at a concentration of about 78% by volume, e.g., in a range from about 70-80%), oxygen (typically present at about 20.95% by volume at sea level, e.g. in a range from about 10% to about 25%), argon (typically present at about 1.0% by volume, e.g. in a range from about 0.1% to about 3%), and carbon dioxide (typically present at about 0.04%, e.g., in a range from about 0.01% to about 0.07%). Air may have other trace gases such as methane, nitrous oxide or ozone, trace pollutants and organic materials such as pollen, diesel particulates and the like. Air may include water vapor (typically present at about 0.25%, or may be present in a range from about 10 ppm to about 5% by volume). Air may be provided for use in culturing experiments as a filtered, controlled composition and may be conditioned as described herein. In embodiments, the bubble includes air.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

### II. Systems & Devices

Spatial sequencing technologies have emerged as powerful tools for analyzing biological samples, enabling researchers to obtain spatially resolved molecular information from tissue sections and other biological specimens. These systems typically employ fluidic pathways to deliver reagents, buffers, and other solutions to flow cells where sequencing reactions occur. Fluidic systems used in spatial sequencing applications involve the controlled movement of liquids through various channels, manifolds, and chambers. The proper functioning of these fluidic pathways is relevant to maintaining the integrity of sequencing reactions and obtaining reliable data. Various factors can affect the performance of such fluidic systems, including the presence of air bubbles within the fluid pathways. Air bubbles can be introduced into fluidic systems through various mechanisms, including during reagent loading, through connections between fluidic components, or through degassing of solutions. When present in fluidic pathways, air bubbles may interfere with the uniform delivery of reagents to flow cells, potentially affecting the quality of sequencing results. Bubbles may also cause inconsistent flow rates or create dead volumes within the fluidic system. Existing approaches to managing air bubbles in fluidic systems include various degassing techniques, bubble traps, and system priming procedures. However, the integration of bubble detection and removal mechanisms within spatial sequencing fluidic systems presents various design considerations, including the geometry of bubble trap structures, the positioning of sensors for bubble detection, and the coordination of valve actuation to redirect bubbles away from flow cells. The design of fluidic manifolds for sequencing applications involves balancing multiple factors, including flow rate requirements, dead volume minimization, and compatibility with various reagents and buffers. The incorporation of bubble management features into such manifolds adds additional design considerations related to the geometry and positioning of bubble trap structures. Accordingly, there exists a general interest in fluidic systems and methods that address bubble management in spatial sequencing applications.

In an aspect is a system configured to remove a bubble from a fluidic pathway of a spatial sequencing system. In embodiments, the system includes: a fluidic pathway; a bubble trap cavity in co mmunication with the fluidic pathway, the bubble trap cavity including a vertical passageway in co mmunication with the fluidic pathway; an optical fluid sensor proximal to the bubble trap cavity, the optical fluid sensor configured to detect a presence of a bubble in or near the bubble trap cavity; a first valve coupled to the fluidic pathway; and a second valve coupled to the fluidic pathway, wherein, upon sensing the presence of the bubble, the optical fluid sensor triggers actuation of the first valve to redirect fluid flow and prevent the bubble from further progressing along the fluid pathway, and further triggers the second valve to divert the bubble into a waste stream.

In embodiments, the bubble trap cavity includes a fluidic manifold formed at least partially of a ramped passageway that fluidly co mmunicates at an upper end with a globular chamber via the vertical passageway. In embodiments, the bubble trap cavity includes a fluidic manifold formed at least partially of a ramped passageway that fluidly co mmunicates at an upper end with a globular chamber via the vertical passageway. In embodiments, the ramped passageway is configured with a gradual incline to guide bubbles toward the vertical passageway while maintaining a continuous fluid flow. In embodiments, the ramped passageway has a curved profile to control fluid acceleration and minimize turbulence near the vertical passageway, thereby enhancing bubble separation. In embodiments, the globular chamber is dimensioned to promote bubble coalescence, allowing smaller bubbles to merge into larger ones for more efficient removal. In embodiments, the globular chamber includes an internal coating of a hydrophobic or hydrophilic material to optimize bubble adhesion or detachment based on fluid composition. For example, in embodiments some portion or all of the globular chamber and/or tube surfaces may be derivatized with low surface-energy materials or chemistries, e.g., by deposition or using in situ synthesis using compounds such as poly-or per-fluorinated compounds in solution or polymerizable monomers. Examples include TEFLON® AF (available from DuPont, Wilmington, Del.), members of the cytop family of materials, coatings in the FLUOROPEL® family of hydrophobic and superhydrophobic coatings (available from Cytonix Corporation, Beltsville, Md.), silane coatings, fluorosilane coatings, hydrophobic phosphonate derivatives (e.g., those sold by Aculon, Inc), and NOVEC™ electronic coatings (available from 3M Company, St. Paul, Minn.), other fluorinated monomers for plasma-enhanced chemical vapor deposition (PECVD), and organosiloxane (e.g., SiOC) for PECVD.

The system includes a fluidic pathway through which fluids such as reagents, buffers, or other solutions may flow during spatial sequencing operations. In some cases, the fluidic pathway may be formed within a manifold structure. The fluidic pathway may include a diffusion-bonded manifold in some embodiments. The system further includes a bubble trap cavity in co mmunication with the fluidic pathway. The bubble trap cavity may be configured to capture and retain bubbles that enter the fluidic pathway, preventing the bubbles from progressing toward downstream components such as a flow cell. The bubble trap cavity includes a vertical passageway in co mmunication with the fluidic pathway. The vertical passageway may allow bubbles to rise and accumulate within the bubble trap cavity due to buoyancy effects resulting from a density differential between air and liquid in the fluidic pathway.

The system can further include an optical fluid sensor disposed proximate the bubble trap cavity and configured to detect a bubble, gas pocket, void, or other discontinuity in a fluid within the bubble trap cavity or in a fluidic pathway fluidically coupled thereto. In some embodiments, the optical fluid sensor is configured to detect bubbles of different sizes and/or optical signatures. In some embodiments, the optical fluid sensor is positioned along an input fluidic pathway upstream of the bubble trap cavity such that the sensor detects a bubble before the bubble enters the bubble trap cavity. The optical fluid sensor can detect a bubble based on a change in an optical property of a fluid region being monitored. In some embodiments, the optical fluid sensor includes a light source and a photodetector arranged such that light passes through, reflects from, or is scattered by fluid in a portion of the fluidic pathway adjacent the bubble trap cavity. When liquid is present in the monitored region, the detected optical signal exhibits a first intensity or signal profile. When a bubble is present in the monitored region, the difference in refractive index, transmission, reflection, and/or scattering between gas and liquid causes a change in the detected optical signal, thereby permitting detection of the bubble. In some embodiments, the sensor detects the bubble when the detected signal differs from a threshold value or deviates from an expected liquid-state signal profile by greater than a predetermined amount.

In embodiments, the vertical passageway connecting the ramped passageway to the globular chamber is tapered to regulate bubble transit and prevent unintended fluid backflow. In embodiments, the system includes a pressure regulation mechanism to modulate fluid velocity through the ramped passageway, thereby optimizing bubble transport without disrupting fluidic stability. In embodiments, the ramped passageway incorporates microtextured surface features to manipulate fluid dynamics and encourage bubble migration toward the vertical passageway. For example, the system may include a series of microgrooves along the ramped passageway to direct bubbles along predefined paths toward the vertical passageway. In embodiments, the system further includes a feedback control system that dynamically adjusts the inclination angle of the ramped passageway based on real-time bubble detection data from the optical fluid sensor. In embodiments, the system integrates an auxiliary fluid injection port near the vertical passageway to introduce a controlled purge stream, assisting in bubble detachment from the fluidic manifold.

In embodiments, the vertical passageway is positioned along a center of the globular chamber. In embodiments, the globular chamber includes a contoured inner surface to guide bubbles toward the vertical passageway, while a tapered profile regulates bubble ascent and prevents backflow. In embodiments, the system adjusts flow dynamics to optimize bubble extraction, such as by incorporating a bypass channel to reduce pressure near the vertical passageway. In embodiments, surface coatings or auxiliary vents further enhance bubble detachment and removal.

In embodiments, the vertical passageway is positioned offset from a center of the globular chamber. In embodiments, the vertical passageway is positioned offset from the center of the globular chamber to direct bubble movement along a controlled flow path. In embodiments, the offset configuration reduces fluid stagnation and enhances bubble migration toward the passageway. In embodiments, the globular chamber includes an asy mmetrical contour to guide bubbles toward the offset vertical passageway. In embodiments, a pressure differential is induced within the chamber to facilitate bubble separation and removal.

In embodiments, the bubble trap cavity comprises a spherical shape. The spherical shape may provide a smooth, continuous internal surface that reduces areas where bubbles could become trapped or fragmented. In some cases, the spherical shape may facilitate the coalescence of smaller bubbles into larger bubbles that are more readily detected by the optical fluid sensor and more easily diverted to the waste stream. The spherical shape may also reduce dead volumes within the bubble trap cavity. In embodiments, the bubble trap cavity comprises a ramp having a spherical or ball end bottom. In embodiments, at least a portion of the globular chamber is chamfered. In embodiments, an upper portion of the globular chamber is chamfered. In embodiments, the chamfered region forms a tapered transition between the chamber walls and the vertical passageway, reducing turbulence and preventing bubble adhesion. The globular chamber may be spherical in some cases. The spherical globular chamber may provide uniform internal geometry that promotes consistent bubble behavior during capture and retention operations. The spherical globular chamber may be sized to acco mmodate expected bubble volumes while maintaining compatibility with the flow rates at which the system operates. In embodiments, the chamfered angles are configured to create a gradual incline, minimizing abrupt changes in flow and ensuring smooth bubble migration. In embodiments, the chamfered design includes multi-angled surfaces to direct bubbles efficiently while maintaining consistent fluid flow. In embodiments, the chamfer incorporates a curved or beveled edge to prevent bubble trapping and facilitate continuous movement toward the waste stream.

The system further includes a first valve coupled to the fluidic pathway and a second valve coupled to the fluidic pathway. Upon sensing the presence of the bubble, the optical fluid sensor may trigger actuation of the first valve to redirect fluid flow and prevent the bubble from further progressing along the fluid pathway. The optical fluid sensor may further trigger the second valve to divert the bubble into a waste stream. In some cases, the system may include an output fluidic pathway in fluid co mmunication with the bubble trap cavity, where the output fluidic pathway may be configured to direct fluid toward a flow cell. The system may also include a waste fluidic pathway in fluid co mmunication with the bubble trap cavity, where the second valve may be configured to divert the bubble into the waste fluidic pathway. In some embodiments, the system may include one or more reagent or buffer input pathways in fluid co mmunication with the fluidic pathway. The system may be configured to operate at a flow rate of 6 to 14 ml/minute in some cases.

The fluidic pathway may be formed using various manufacturing techniques and configurations. In some embodiments, the fluidic pathway comprises a diffusion-bonded manifold. The diffusion-bonded manifold may be formed by bonding multiple layers of material together under heat and pressure to create internal fluid channels and passages. The diffusion bonding process may involve placing layers of material, such as metal or polymer sheets, in contact with one another and applying elevated temperature and pressure over a period of time. During the diffusion bonding process, atoms at the interface between adjacent layers may migrate across the boundary, creating a solid-state bond without melting the base materials. The resulting diffusion-bonded manifold may provide a sealed, leak-free structure with smooth internal surfaces that facilitate fluid flow and reduce the potential for bubble entrapment at joints or seams.

The diffusion-bonded manifold may include multiple internal channels, chambers, and passages formed by selectively removing material from individual layers prior to bonding. In some cases, the internal geometry of the diffusion-bonded manifold may be designed to acco mmodate the bubble trap cavity, the vertical passageway, and associated fluid channels. The diffusion-bonded manifold may provide structural integrity and dimensional stability suitable for operation at flow rates of 6 to 14 ml/minute, as described previously.

The fluidic pathway may further comprise a curved fluid channel in fluid co mmunication with the vertical passageway. The curved fluid channel may be configured to guide fluid flow toward or away from the vertical passageway. In some cases, the curved fluid channel may facilitate the movement of bubbles toward the bubble trap cavity by creating flow patterns that encourage bubble migration. The curved fluid channel may have a radius of curvature selected to maintain laminar flow conditions and reduce turbulence that could fragment bubbles into smaller, more difficult to capture sizes. The curved fluid channel may be formed within the diffusion-bonded manifold during the layer fabrication and bonding process. In some embodiments, the curved fluid channel may connect the vertical passageway to other portions of the fluidic pathway, such as input pathways or output pathways leading toward a flow cell.

The bubble trap cavity in co mmunication with the fluidic pathway, as described previously, may be configured with various structural features to facilitate bubble capture and retention. The bubble trap cavity includes a vertical passageway in co mmunication with the fluidic pathway, where the vertical passageway may allow bubbles to rise due to buoyancy effects.

In some embodiments, the bubble trap cavity includes a fluidic manifold formed at least partially of a ramped passageway that fluidly co mmunicates at an upper end with a globular chamber via the vertical passageway. The ramped passageway may be oriented at an angle relative to horizontal such that fluid flowing through the ramped passageway experiences a gradual elevation change. Bubbles present in the fluid may tend to migrate toward the upper end of the ramped passageway due to the density differential between air and liquid. At the upper end of the ramped passageway, the vertical passageway may provide a conduit through which bubbles can rise into the globular chamber. The globular chamber may serve as a collection region where bubbles accumulate and are retained until diverted to a waste stream.

The vertical passageway may be fluidly connected to a ramped passageway at a top end of the ramped passageway. The connection at the top end of the ramped passageway may allow bubbles that have migrated along the ramped passageway to enter the vertical passageway and rise into the globular chamber. The ramped passageway may have various dimensions depending on the application and flow characteristics of the system. In embodiments, the ramp measures approximately 2 mm in length and 1 mm in width, providing a controlled incline for fluid and bubble movement. In embodiments, the bubble trap cavity has a 1 mm diameter, ensuring efficient bubble capture and retention. In embodiments, the cavity features a 60-degree chamfered top, creating a smooth transition that minimizes turbulence and facilitates bubble detachment toward the vertical passageway. In embodiments, the ramp is 2×1 mm, and wherein the bubble trap cavity has a diameter of 1 mm and a 60 degree chamfered top.

In embodiments, the vertical passageway is fluidly connected to a ramped passageway at a top end of the ramped passageway.

In embodiments, the bubble trap cavity may include a flow restrictor or pressure modulation mechanism to regulate bubble movement and prevent fluid backflow into the vertical passageway. In embodiments, the internal surfaces of the ramped passageway and globular chamber may be coated with hydrophobic or hydrophilic materials to influence bubble adhesion and detachment based on fluid properties. In embodiments, the vertical passageway may incorporate a variable-diameter profile, with a narrower lower section to improve bubble retention and a wider upper section to facilitate smooth extraction. Additionally, in embodiments, the system may include a vent or auxiliary fluid inlet near the vertical passageway to assist in purging trapped bubbles, ensuring uninterrupted fluid flow and efficient bubble removal.

In embodiments, the system further includes a sample stage configured to retain a flow cell. The flow cell as described herein includes one or more fluidic channels that allow for two or more independent reactions, such as amplification and/or sequencing chemistry to occur within the same reaction chamber, at different time points.

In any of the embodiments described herein, each channel has a structure configuration that is configured to enable fluid flow through a channel. A structure configuration of at least one of the channels can vary. In an embodiment, at least one channel has a cross sectional shape of a circle, rectangle, oval, or any other shape. Preferably, the flow rates, fluid viscosities, compositions, and geometries and sizes of the channel are selected so that fluid flow is laminar. Guidance for configuring such channel is readily available publicly available resources, for example Acheson, Elementary Fluid Dynamics (Clarendon Press, 1990), and from software for modeling fluidics systems, e.g. SolidWorks from Dassault Systems. In an embodiment, at least one channel has passage cross-sections in the range of tens of square microns to a few square millimeters (e.g., maximal cross-sectional dimensions of from about 500 μm to about 0.1 μm). In an embodiment, the flow rates in the range of from a few nL/sec to a hundreds of μL/sec.In an embodiment, volume capacities in are the range of from 1 μm to a few nL, e.g. 10-100 nL. In embodiments, the flow rates is about 2-5 ml/minute. In embodiments, the flow rates is about 6-10 ml/minute. In embodiments, the flow rates is about 10-15 ml/minute.

In embodiments, the system is configured to operate at a flow rate of 6 to 14 ml/minute. The flow rate range of 6 to 14 ml/minute may be selected to balance efficient fluid delivery with effective bubble detection and removal during spatial sequencing operations. The flow rate at which the system operates may influence several aspects of bubble management within the fluidic pathway. At lower flow rates within the 6 to 14 ml/minute range, such as flow rates approaching 6 ml/minute, bubbles may have increased residence time within the bubble trap cavity region. The increased residence time may allow bubbles to migrate more completely into the bubble trap cavity due to buoyancy effects, as the reduced fluid velocity may provide additional time for the density differential between air and liquid to drive bubble movement toward the vertical passageway and globular chamber. Lower flow rates may also provide the optical fluid sensor with extended detection windows for identifying bubbles as the bubbles pass through the detection region.

At higher flow rates within the 6 to 14 ml/minute range, such as flow rates approaching 14 ml/minute, fluid delivery to the flow cell may be more rapid, which may reduce the overall time for spatial sequencing operations. Higher flow rates may increase the velocity of fluid through the fluidic pathway, which may affect the trajectory and behavior of bubbles within the system. The bubble trap cavity geometry, including the ramped passageway, vertical passageway, and globular chamber as described previously, may be configured to acco mmodate bubble capture at flow rates throughout the 6 to 14 ml/minute range.

In some cases, the flow rate may be selected based on the specific reagent or buffer being delivered through the fluidic pathway. Different reagents or buffers may have varying viscosities, surface tensions, or other fluid properties that influence bubble formation and behavior. The flow rate may be adjusted within the 6 to 14 ml/minute range to acco mmodate these variations while maintaining effective bubble detection and removal. In some embodiments, the flow rate may be dynamically adjusted during spatial sequencing operations based on feedback from the optical fluid sensor or other system sensors. The system may increase or decrease the flow rate within the 6 to 14 ml/minute range in response to detected bubble frequency, bubble size, or other parameters indicative of bubble presence within the fluidic pathway.

In embodiments, the at least one fluid channel further includes a fluidic connection to a waste reservoir. A waste reservoir is a container capable of receiving fluids from the flow cell and/or retaining the fluidic discharge until disposing the fluids. In embodiments, the waste reservoir is capable of containing 1 L to 10 L of fluid. In embodiments, the waste reservoir is capable of containing 3 L to 6 L of fluid. In embodiments, the waste reservoir is capable of containing 5 L of fluid.

In embodiments, the system is configured to remove a bubble from a fluidic pathway of a spatial sequencing system. The system may be employed in spatial sequencing applications where the presence of bubbles in fluidic pathways can interfere with sequencing operations. Bubble removal from fluidic pathways may improve the reliability and consistency of spatial sequencing processes. The system includes a fluidic pathway through which fluids such as reagents, buffers, and other solutions may flow during sequencing operations. The fluidic pathway may be formed within a manifold structure or other suitable fluidic architecture. In some cases, the fluidic pathway may include multiple interconnected channels and passages that direct fluid flow through various components of the spatial sequencing system.

In embodiments, the system includes a bubble trap cavity in co mmunication with the fluidic pathway. The bubble trap cavity includes a vertical passageway in co mmunication with the fluidic pathway. The vertical passageway may allow bubbles to rise and collect within the bubble trap cavity due to buoyancy effects. The bubble trap cavity may be positioned along the fluidic pathway at a location where bubble accumulation is likely to occur or where bubble removal is desired prior to fluid reaching downstream components.

The system further includes an optical fluid sensor proximal to the bubble trap cavity. The optical fluid sensor is configured to detect a presence of a bubble in or near the bubble trap cavity. The optical fluid sensor may utilize light transmission, reflection, or other optical properties to distinguish between liquid and gas phases within the fluidic pathway. In some cases, the optical fluid sensor may be a high dynamic-range sensor capable of detecting bubbles of varying sizes. In embodiments, the system includes a first valve coupled to the fluidic pathway and a second valve coupled to the fluidic pathway. Upon sensing the presence of the bubble, the optical fluid sensor triggers actuation of the first valve to redirect fluid flow and prevent the bubble from further progressing along the fluid pathway. The optical fluid sensor further triggers the second valve to divert the bubble into a waste stream. The coordinated actuation of the first valve and the second valve may allow for bubble removal without interrupting the overall sequencing process. The system may be configured to operate at a flow rate of 6 to 14 ml/minute. In some cases, the system may operate at flow rates ranging from 2 to 14 ml/minute depending on the specific sequencing application and fluid properties. The flow rate may be selected to balance efficient fluid delivery with effective bubble detection and removal.

Straight vertical channel configurations may include various ramped passageway dimensions. In some embodiments, the straight vertical channel configuration may include no ramp, where the vertical passageway connects directly to the fluidic pathway without an intervening ramped passageway. In some embodiments, the straight vertical channel configuration may include a 1.5×1 mm ramp, where the ramped passageway has dimensions of approximately 1.5 mm in length and 1 mm in width or height. In some embodiments, the straight vertical channel configuration may include a 2.25×1 mm ramp, where the ramped passageway has dimensions of approximately 2.25 mm in length and 1 mm in width or height. In some embodiments, the straight vertical channel configuration may include a 3×1.5 mm ramp, where the ramped passageway has dimensions of approximately 3 mm in length and 1.5 mm in width or height.

Offset vertical channel configurations may also include various ramped passageway dimensions. In some embodiments, the offset vertical channel configuration may include a 1×1 mm ramp, where the ramped passageway has dimensions of approximately 1 mm in length and 1 mm in width or height. In some embodiments, the offset vertical channel configuration may include a 1.5×1 mm ramp. In some embodiments, the offset vertical channel configuration may include a 2.25×1 mm ramp. In some embodiments, the offset vertical channel configuration may include a 3×1.5 mm ramp.

Experimental results indicated that straight vertical channel configurations exhibited bubble trapping performance that exceeded the bubble trapping performance of offset vertical channel configurations. The straight vertical channel configurations, where the vertical passageway is positioned along a center of the globular chamber, may provide more effective bubble capture due to the direct vertical path available for bubble rise. The offset vertical channel configurations, where the vertical passageway is positioned offset from a center of the globular chamber, may result in bubbles following a less direct path into the globular chamber, which may reduce capture efficiency under certain flow conditions.

The globular chamber, as described previously, may include various structural features configured to facilitate bubble movement and retention within the bubble trap cavity. In some embodiments, at least a portion of the globular chamber is chamfered. The chamfered portion may comprise an angled or beveled surface that transitions between different regions of the globular chamber. The chamfered portion may reduce sharp corners or edges within the globular chamber that could otherwise impede bubble movement or cause bubble fragmentation.

In some embodiments, an upper portion of the globular chamber is chamfered. The chamfered upper portion may provide a tapered or angled surface at the top region of the globular chamber. The chamfered upper portion may facilitate bubble movement by guiding bubbles toward a collection region within the globular chamber. The angled surface of the chamfered upper portion may encourage bubbles to coalesce and accumulate at a designated location within the globular chamber, which may improve the efficiency of bubble diversion to the waste stream when the second valve is actuated. The chamfered portion of the globular chamber may have various angular configurations. In some cases, the chamfered portion may have a chamfer angle of approximately 60 degrees relative to a horizontal plane. Other chamfer angles may be employed depending on the specific geometry of the bubble trap cavity and the flow characteristics of the system. The chamfered portion may extend around a circumference of the globular chamber in some embodiments, or the chamfered portion may be present along a portion of the circumference.

A portion of the globular chamber may be chamfered to facilitate bubble movement within the bubble trap cavity. The chamfered portion may create a smooth transition surface that reduces resistance to bubble migration. The chamfered geometry may promote the natural tendency of bubbles to rise due to buoyancy effects by providing an unobstructed path toward the upper regions of the globular chamber. The chamfered portion may also reduce the likelihood of bubbles becoming lodged or trapped at corners within the globular chamber during fluid flow operations. The bubble trap cavity, as described previously, may include various geometric configurations to facilitate bubble capture and retention. In some embodiments, the bubble trap cavity comprises a ramp having a spherical or ball end bottom. The spherical or ball end bottom may provide a smooth, curved surface at the lower portion of the ramp that facilitates fluid flow and bubble movement. The spherical or ball end bottom may reduce areas where bubbles could become trapped or stagnate, promoting consistent bubble migration toward the globular chamber.

In some embodiments, the ramp is 2×1 mm, and the bubble trap cavity has a diameter of 1 mm and a 60 degree chamfered top. The 2×1 mm ramp dimensions may correspond to a ramp length of approximately 2 mm and a ramp width or height of approximately 1 mm. The 1 mm diameter of the bubble trap cavity may refer to the diameter of the vertical passageway or the globular chamber opening through which bubbles enter the collection region. The 60 degree chamfered top may provide an angled upper surface that facilitates bubble coalescence and accumulation within the globular chamber.

In some embodiments, the bubble trap cavity further comprises a teardrop-shaped lead-in region. The teardrop-shaped lead-in region may be positioned upstream of the ramp or at the entrance to the bubble trap cavity. The teardrop-shaped lead-in region may provide a gradual transition from the fluidic pathway into the bubble trap cavity, which may reduce turbulence and promote smooth fluid flow. The teardrop shape may include a wider upstream portion that tapers to a narrower downstream portion, guiding fluid and bubbles toward the ramp and vertical passageway.

Various ball-end bottom configurations may be employed depending on the application and flow characteristics of the system. In some embodiments, the ball-end bottom configuration may include a ball-end bottom with 1 mm diameter trap and 60° chamfered top. In some embodiments, the ball-end bottom configuration may include a ball-end bottom with teardrop lead-in, 1 mm trap diameter, and 60° chamfered top. In some embodiments, the ball-end bottom configuration may include a ball-end bottom with large teardrop lead-in, 1.5 mm trap diameter, and 60° chamfered top. In some embodiments, the ball-end bottom configuration may include a ball-end bottom with 2×1 mm ball-end ramp, 1 mm trap diameter, and 60° chamfered top. In some embodiments, the ball-end bottom configuration may include a ball-end bottom with interpolated ramp and 1 mm trap diameter. In some embodiments, the ball-end bottom configuration may include a ball-end bottom with no ramp, 1 mm trap diameter, and 60° chamfered top. In some embodiments, the ball-end bottom configuration may include a ball-end bottom with 2×1 mm straight ramp, 1 mm trap diameter, and 60° chamfered top.

Experimental results demonstrated that the ball-end bottom with 2×1 mm ball-end ramp, 1 mm trap diameter, and 60° chamfered top was effective in both trapping and removing bubbles. The ball-end bottom with 2×1 mm ball-end ramp, 1 mm trap diameter, and 60° chamfered top configuration may leverage the combined effects of buoyancy, channel geometry, and fluid dynamics to enhance bubble extraction efficiency. The spherical or ball end bottom of the ramp may promote smooth fluid flow transitions, while the 2×1 mm ramp dimensions may provide an appropriate angle and length for bubble migration toward the vertical passageway. The 1 mm trap diameter may acco mmodate bubbles of various sizes, and the 60° chamfered top may facilitate bubble coalescence and retention within the globular chamber until diversion to the waste stream.

The optical fluid sensor proximal to the bubble trap cavity, as described previously, may be configured to detect a presence of a bubble in or near the bubble trap cavity. The optical fluid sensor may employ various detection principles to identify bubbles within the fluidic pathway. In some cases, the optical fluid sensor may utilize light transmission, light reflection, or light scattering measurements to distinguish between liquid and gas phases within the fluidic pathway. The optical fluid sensor may emit light toward the fluidic pathway and measure changes in light intensity, light direction, or light characteristics that occur when a bubble passes through the detection region.

In some embodiments, the presence of the bubble is identified using an optical fluid sensor. The optical fluid sensor may provide real-time detection of bubbles as the bubbles travel through the fluidic pathway toward the bubble trap cavity. The optical fluid sensor may generate a signal upon detecting a bubble, where the signal may trigger actuation of the first valve and the second valve as described previously. The optical fluid sensor may be calibrated to detect bubbles of various sizes, including small bubbles that could interfere with spatial sequencing operations if allowed to reach the flow cell.

In some embodiments, the optical fluid sensor is a high dynamic-range sensor. The high dynamic-range sensor may be capable of detecting bubbles across a wide range of sizes and optical characteristics. The high dynamic-range sensor may acco mmodate variations in fluid opacity, fluid color, or fluid composition that may occur during spatial sequencing operations when different reagents or buffers flow through the fluidic pathway. The high dynamic-range sensor may maintain detection accuracy under varying lighting conditions or fluid flow rates. The high dynamic-range sensor may provide consistent bubble detection performance when the system operates at flow rates of 6 to 14 ml/minute, as described previously.

In some embodiments, the optical fluid sensor is positioned adjacent the bubble trap cavity. The adjacent positioning may allow the optical fluid sensor to detect bubbles as the bubbles approach or enter the bubble trap cavity. The adjacent positioning may provide proximity between the detection region and the bubble trap cavity, which may reduce the time delay between bubble detection and bubble capture within the bubble trap cavity.

In some embodiments, the optical fluid sensor is positioned along an input fluidic pathway upstream of the bubble trap cavity. The upstream positioning may allow the optical fluid sensor to detect bubbles before the bubbles reach the bubble trap cavity. The upstream positioning may provide advance notice of bubble presence, allowing the system to prepare for valve actuation and bubble diversion operations. The optical fluid sensor positioned along the input fluidic pathway upstream of the bubble trap cavity may detect bubbles as the bubbles enter the system from reagent or buffer input pathways, providing early detection that may improve bubble capture efficiency.

The system includes a first valve coupled to the fluidic pathway and a second valve coupled to the fluidic pathway, as described previously. The first valve and the second valve may be configured to operate in coordination with the optical fluid sensor to manage bubble removal from the fluidic pathway.

The first valve coupled to the fluidic pathway may be positioned along the fluidic pathway at a location that allows the first valve to control fluid flow direction within the system. The first valve may be a solenoid valve, a pinch valve, a diaphragm valve, or another type of valve suitable for controlling fluid flow in microfluidic or fluidic systems. The first valve may be configured to transition between an open state and a closed state, or between multiple flow path configurations, in response to control signals received from a controller or directly from the optical fluid sensor.

The second valve coupled to the fluidic pathway may be positioned along the fluidic pathway at a location that provides fluid co mmunication between the bubble trap cavity and a waste stream pathway. The second valve may be a solenoid valve, a pinch valve, a diaphragm valve, or another type of valve suitable for diverting fluid and bubbles toward the waste stream. The second valve may be configured to transition between a closed state, in which fluid flows toward the flow cell, and an open state, in which fluid and bubbles are diverted toward the waste stream.

Upon sensing the presence of the bubble, the optical fluid sensor triggers actuation of the first valve to redirect fluid flow and prevent the bubble from further progressing along the fluid pathway. The optical fluid sensor may generate a detection signal when a bubble is detected in or near the bubble trap cavity. The detection signal may be transmitted to a controller or directly to the first valve to initiate valve actuation. The first valve may transition from a first configuration to a second configuration in response to the detection signal, where the second configuration redirects fluid flow such that the bubble is prevented from moving toward the flow cell. The redirection of fluid flow may cause the bubble to migrate into the bubble trap cavity due to buoyancy effects and the altered flow pattern within the fluidic pathway.

Upon sensing the presence of the bubble, the optical fluid sensor further triggers the second valve to divert the bubble into a waste stream. The optical fluid sensor may generate a second detection signal or a combined detection signal that initiates actuation of the second valve. The second valve may transition from a closed state to an open state in response to the detection signal, establishing fluid co mmunication between the bubble trap cavity and the waste stream pathway. The bubble accumulated within the bubble trap cavity may be diverted into the waste stream through the open second valve. In some cases, fluid flow through the system may carry the bubble from the bubble trap cavity through the second valve and into the waste stream pathway.

The first valve and the second valve may be actuated sequentially or simultaneously depending on the system configuration and the timing requirements for bubble removal. In some embodiments, the first valve may be actuated before the second valve to allow the bubble to migrate into the bubble trap cavity prior to diversion to the waste stream. In some embodiments, the first valve and the second valve may be actuated simultaneously to provide rapid bubble removal from the fluidic pathway. The actuation timing of the first valve and the second valve may be controlled by a controller that receives the detection signal from the optical fluid sensor and coordinates valve operations based on predetermined timing parameters or real-time flow conditions.

The system, as described previously, includes various fluidic pathways configured to manage fluid flow during spatial sequencing operations. The system further comprises an output fluidic pathway in fluid co mmunication with the bubble trap cavity. The output fluidic pathway may be configured to direct fluid toward a flow cell. The output fluidic pathway may extend from the bubble trap cavity or from a region of the fluidic pathway downstream of the bubble trap cavity toward the flow cell where spatial sequencing reactions occur. The output fluidic pathway may carry reagents, buffers, or other solutions that have passed through the bubble trap cavity region, where bubbles have been removed or diverted prior to the fluid reaching the flow cell. The output fluidic pathway may be formed within the diffusion-bonded manifold, as described previously, or the output fluidic pathway may comprise tubing, channels, or other conduits that connect the bubble trap cavity region to the flow cell. The output fluidic pathway configured to direct fluid toward a flow cell may provide a bubble-free fluid stream to the flow cell, which may improve the accuracy and reliability of spatial sequencing operations by reducing interference from bubbles during imaging or reagent delivery.

The system further incldues a waste fluidic pathway in fluid co mmunication with the bubble trap cavity. The waste fluidic pathway may extend from the bubble trap cavity toward a waste collection reservoir or waste outlet. The waste fluidic pathway may receive bubbles and associated fluid that are diverted from the bubble trap cavity during bubble removal operations. The second valve, as described previously, is configured to divert the bubble into the waste fluidic pathway. When the second valve transitions to an open state in response to bubble detection by the optical fluid sensor, fluid co mmunication may be established between the bubble trap cavity and the waste fluidic pathway, allowing bubbles accumulated within the bubble trap cavity to be carried into the waste fluidic pathway. The waste fluidic pathway may be formed within the diffusion-bonded manifold or may comprise separate tubing or channels that connect to the bubble trap cavity region. The waste fluidic pathway in fluid co mmunication with the bubble trap cavity may provide a dedicated route for bubble removal that is separate from the output fluidic pathway, preventing diverted bubbles from reaching the flow cell.

The system further comprises one or more reagent or buffer input pathways in fluid co mmunication with the fluidic pathway. The one or more reagent or buffer input pathways may be configured to introduce reagents, buffers, wash solutions, or other fluids into the fluidic pathway during spatial sequencing operations. The one or more reagent or buffer input pathways may connect to the fluidic pathway at locations upstream of the bubble trap cavity, allowing fluids introduced through the input pathways to pass through the bubble trap cavity region where bubbles may be detected and removed. In some cases, the one or more reagent or buffer input pathways may include multiple separate input channels, each configured to deliver a different reagent or buffer to the fluidic pathway. The one or more reagent or buffer input pathways in fluid co mmunication with the fluidic pathway may be formed within the diffusion-bonded manifold or may comprise separate tubing or channels that connect to the fluidic pathway. The one or more reagent or buffer input pathways may be coupled to reagent reservoirs, buffer reservoirs, or fluid handling systems that supply fluids to the spatial sequencing system during operation.

The system and method described herein may provide various features that facilitate bubble management in spatial sequencing applications. In some embodiments, the system employs active optical detection and valve control, where an optical fluid sensor detects bubble presence and triggers coordinated actuation of valves to redirect flow and divert bubbles to a waste stream, rather than relying on passive pressure differential-based trapping. The system may actively remove bubbles to a waste stream through valve actuation, rather than passively retaining bubbles in a trap chamber. In some cases, the fluidic pathway comprises a diffusion-bonded manifold formed by bonding multiple layers of material under heat and pressure, which may provide sealed internal channels with smooth surfaces that facilitate fluid flow. The bubble trap cavity may include specific optimized geometries, such as a ball-end bottom, a 2×1 mm ramp, a 1 mm trap diameter, a 60° chamfered top, and a teardrop-shaped lead-in region, which may enhance bubble capture and removal efficiency. The system may be configured to operate at a flow rate of 6 to 14 ml/minute, acco mmodating the fluid delivery requirements of spatial sequencing applications. In some embodiments, the optical fluid sensor is a high dynamic-range sensor capable of detecting bubbles across a range of sizes and fluid compositions. The system may provide real-time, dynamic control of bubble removal with millisecond-scale response times, enabling rapid valve actuation in response to detected bubbles.

### III. Methods

In an aspect is a method of removing a bubble from a fluidic pathway of a spatial sequencing system. The method may comprise identifying presence of a bubble near a bubble trap cavity of the fluidic pathway; actuating a first valve coupled to the fluidic pathway to cause the bubble to migrate into the bubble trap cavity; redirecting fluid through the fluidic pathway such that the bubble is prevented from moving toward a flow cell; and activating a second valve to divert the bubble from the bubble trap cavity toward a waste stream pathway. The bubble trap cavity comprises a fluidic manifold formed at least partially of a ramped passageway that fluidly co mmunicates with a globular chamber, which can be spherical and at least partially chamfered.

The presence of the bubble is identified using an optical fluid sensor such as a high dynamic-range sensor. The optical fluid sensor is positioned adjacent the bubble trap cavity. The bubble migrates into the bubble trap cavity due to a density differential between air and liquid in the fluidic pathway. The valve actuation can occur after a time delay, wherein the time delay can be on a millisecond time scale. The method may be employed to detect and eliminate bubbles that enter the fluidic pathway during spatial sequencing operations, preventing the bubbles from interfering with downstream processes such as imaging or reagent delivery at a flow cell.

In embodiments, the method includes detecting the presence of a bubble near a bubble trap cavity of the fluidic pathway using an optical fluid sensor, such as a high dynamic-range sensor positioned adjacent to the bubble trap cavity. Upon detection, the method may include actuating a first valve coupled to the fluidic pathway to direct the bubble into the bubble trap cavity. The bubble migrates into the cavity due to a density differential between air and liquid in the fluidic pathway. The method may further comprise redirecting fluid flow to prevent the bubble from advancing toward a flow cell and activating a second valve to divert the bubble from the bubble trap cavity into a waste stream pathway.

In embodiments, the bubble trap cavity comprises a fluidic manifold formed at least partially of a ramped passageway that fluidly co mmunicates with a globular chamber. In embodiments, the bubble trap cavity comprises a fluidic manifold formed at least partially of a ramped passageway that fluidly co mmunicates with a globular chamber to facilitate controlled bubble separation and removal. In embodiments, the ramped passageway is designed to guide bubbles toward the globular chamber, where they are temporarily retained before extraction. In embodiments, the globular chamber may be spherical or partially chamfered to optimize fluid flow and prevent bubble adhesion. In embodiments, the ramped passageway may have a gradual incline or stepped profile to regulate bubble migration while minimizing turbulence.

In embodiments, the globular chamber is spherical.

In embodiments, a portion of the globular chamber is chamfered.

In embodiments, the presence of the bubble is identified using an optical fluid sensor.

In embodiments, the optical fluid sensor is a high dynamic-range sensor.

In embodiments, the optical fluid sensor is positioned adjacent to the bubble trap cavity.

In embodiments, the bubble migrates into the bubble trap cavity due to a density differential between air and liquid in the fluidic pathway.

The fluids flowing through the fluidic pathway during spatial sequencing operations may include various compositions depending on the stage of the sequencing process. In some cases, the fluids may include nucleotides, such as deoxyribonucleotides or modified nucleotides, that are incorporated during sequencing reactions. The fluids may include oligonucleotides, such as primers, probes, or adapters, that hybridize to target sequences or facilitate library preparation. In some embodiments, the fluids may include reagents for sequencing, such as polymerases, ligases, or other enzymes that catalyze nucleotide incorporation or ligation reactions. The fluids may include reducing agents, such as dithiothreitol or tris(2-carboxyethyl)phosphine, that maintain appropriate redox conditions during sequencing reactions. In some cases, the fluids may include buffered solutions, such as Tris-based buffers, phosphate buffers, or other buffering systems, that maintain pH stability during fluidic operations. The fluids may also include salts, detergents, blocking agents, or other additives that support sequencing chemistry or reduce non-specific binding. In some embodiments, the fluids may include wash solutions configured to remove unbound reagents or reaction byproducts from the flow cell between sequencing cycles.

In embodiments, the valve actuation occurs after a time delay. In embodiments, the time delay is on a millisecond time scale. In embodiments, the time delay is 1, 2, 3, 4, 5, 6, 7, 8, 9, or 10 milliseconds.

In embodiments, the fluidic pathway comprises a diffusion-bonded manifold. In embodiments, the diffusion-bonded manifold is formed from stainless steel. In embodiments, the diffusion-bonded manifold is formed from titanium. In embodiments, the diffusion-bonded manifold is formed from aluminum. In embodiments, the diffusion-bonded manifold is formed from silicon. In embodiments, the diffusion-bonded manifold is formed from ceramic. In embodiments, the diffusion-bonded manifold comprises a multi-layered structure. In embodiments, the diffusion-bonded manifold comprises microchannels formed through chemical etching. In embodiments, the diffusion-bonded manifold comprises laser-cut microchannels. In embodiments, the diffusion-bonded manifold comprises stacked and bonded thin plates. In embodiments, the diffusion-bonded manifold comprises integrated pressure regulation features.

In embodiments, the bubble migrates into the bubble trap cavity without flushing of the fluidic pathway.

One or more liquids or solutions may be degassed to improve performance of the microfluidic device and/or sequencing results. In embodiments, one or more of the solutions may be degassed upstream of the flow cell. In embodiments where more than one solution is degassed, these may be grouped in a single vacuum chamber. In embodiments where more than one solution is degassed, more than one vacuum chamber or vacuum system may be used.

The method includes identifying presence of a bubble near a bubble trap cavity of the fluidic pathway. The presence of the bubble may be identified using an optical fluid sensor, as described previously. The optical fluid sensor may detect the bubble as the bubble approaches or enters a region proximal to the bubble trap cavity. In some cases, the optical fluid sensor may be a high dynamic-range sensor capable of detecting bubbles of varying sizes and optical characteristics. The optical fluid sensor may be positioned adjacent the bubble trap cavity in some embodiments. In some embodiments, the optical fluid sensor may be positioned along an input fluidic pathway upstream of the bubble trap cavity, providing advance detection of bubbles before the bubbles reach the bubble trap cavity region. The identification of bubble presence may generate a detection signal that initiates subsequent steps of the method.

The method includes actuating a first valve coupled to the fluidic pathway to cause the bubble to migrate into the bubble trap cavity. The first valve, as described previously, may be coupled to the fluidic pathway at a location that allows the first valve to control fluid flow direction within the system. Actuating the first valve may alter the flow pattern within the fluidic pathway such that the bubble is directed toward the bubble trap cavity. The bubble may migrate into the bubble trap cavity due to a density differential between air and liquid in the fluidic pathway. The density differential may cause the bubble to rise toward the vertical passageway and into the globular chamber of the bubble trap cavity due to buoyancy effects. In some cases, the bubble may migrate into the bubble trap cavity without flushing of the fluidic pathway, as the buoyancy-driven migration may occur passively once the flow pattern is altered by the first valve actuation.

In some embodiments, actuating the first valve occurs after a time delay. The time delay may allow the bubble to travel to a position where actuation of the first valve provides effective redirection of the bubble toward the bubble trap cavity. In some cases, the time delay may be on a millisecond time scale. The millisecond time scale delay may be calibrated based on the flow rate at which the system operates and the distance between the optical fluid sensor and the bubble trap cavity. The time delay may be controlled by a controller that receives the detection signal from the optical fluid sensor and initiates valve actuation after the predetermined delay period.

The method includes redirecting fluid through the fluidic pathway such that the bubble is prevented from moving toward a flow cell. The redirection of fluid may result from the actuation of the first valve, which may transition the first valve from a first configuration to a second configuration. In the second configuration, fluid flow may be directed along a path that does not carry the bubble toward the flow cell. The redirection may cause the bubble to remain within or migrate further into the bubble trap cavity while fluid continues to flow through the fluidic pathway. The bubble may be retained within the globular chamber of the bubble trap cavity during the redirection of fluid flow.

The method includes activating a second valve to divert the bubble from the bubble trap cavity toward a waste stream pathway. The second valve, as described previously, may be coupled to the fluidic pathway at a location that provides fluid co mmunication between the bubble trap cavity and the waste stream pathway. Activating the second valve may transition the second valve from a closed state to an open state, establishing a flow path from the bubble trap cavity to the waste stream pathway. The bubble accumulated within the bubble trap cavity may be carried through the open second valve and into the waste stream pathway by fluid flow. The waste stream pathway may direct the diverted bubble toward a waste collection reservoir or waste outlet, removing the bubble from the spatial sequencing system.

The bubble trap cavity, as described previously, may comprise a fluidic manifold formed at least partially of a ramped passageway that fluidly co mmunicates with a globular chamber. The ramped passageway may facilitate bubble migration toward the globular chamber during the method. The globular chamber may be spherical in some cases, providing a smooth internal surface that promotes bubble coalescence and retention. A portion of the globular chamber may be chamfered to facilitate bubble movement within the bubble trap cavity during the method.

The fluidic pathway may comprise a diffusion-bonded manifold, as described previously. The diffusion-bonded manifold may provide sealed internal channels and passages through which fluid flows during the method. The diffusion-bonded manifold may acco mmodate the bubble trap cavity, the first valve, the second valve, and associated fluid pathways within an integrated structure. In embodiments, the fluidic pathway includes a pressure sensitive mylar adhesive to form a channel.

The bubble, as described previously, migrates into the bubble trap cavity due to a density differential between air and liquid in the fluidic pathway. The density differential arises from the difference in mass per unit volume between gaseous bubbles, which are composed primarily of air, and the liquid phase of the fluid flowing through the fluidic pathway. Air has a density that is substantially lower than the density of aqueous solutions, reagents, or buffers that may flow through the fluidic pathway during spatial sequencing operations. The density differential creates a buoyancy force that acts on bubbles within the fluidic pathway, causing the bubbles to experience an upward force relative to the surrounding liquid.

Buoyancy effects resulting from the density differential cause bubbles to rise within the fluidic pathway. When a bubble is present within the fluidic pathway, the surrounding liquid exerts a net upward force on the bubble due to the pressure gradient within the liquid. The pressure at the bottom of the bubble is greater than the pressure at the top of the bubble, resulting in a net force directed upward. The magnitude of the buoyancy force depends on the volume of the bubble and the density differential between the air within the bubble and the liquid surrounding the bubble. Larger bubbles may experience greater buoyancy forces and may rise more rapidly within the fluidic pathway compared to smaller bubbles.

The bubble may migrate into the bubble trap cavity without flushing of the fluidic pathway. The buoyancy-driven migration of bubbles toward the bubble trap cavity may occur passively as a result of the density differential between air and liquid, without requiring active flushing or purging of the fluidic pathway with additional fluid. When the first valve is actuated to alter the flow pattern within the fluidic pathway, as described previously, the bubble may rise toward the vertical passageway and enter the globular chamber of the bubble trap cavity due to the buoyancy force acting on the bubble. The passive migration of bubbles into the bubble trap cavity without flushing may reduce fluid consumption during bubble removal operations and may minimize disruption to ongoing spatial sequencing processes. The geometry of the bubble trap cavity, including the ramped passageway and vertical passageway as described previously, may be configured to facilitate buoyancy-driven bubble migration by providing an upward path along which bubbles can travel into the globular chamber.

The actuation of the first valve coupled to the fluidic pathway, as described previously, may occur after a time delay. The time delay may be a predetermined interval between the detection of a bubble by the optical fluid sensor and the initiation of valve actuation. The time delay may allow the system to prepare for valve actuation and may provide time for the bubble to travel to a position within the fluidic pathway where actuation of the first valve provides effective redirection of the bubble toward the bubble trap cavity.

In some embodiments, the time delay is on a millisecond time scale. The millisecond time scale may correspond to time delays ranging from approximately one millisecond to several hundred (e.g., 1-500 ms) milliseconds, depending on the flow rate at which the system operates and the distance between the optical fluid sensor and the bubble trap cavity. The millisecond time scale time delay may be selected to account for the transit time of the bubble from the detection region of the optical fluid sensor to the region of the fluidic pathway where the first valve can effectively redirect the bubble toward the bubble trap cavity. In embodiments, the time delay is 1 to 5 ms.

The time delay may be calibrated based on the flow rate at which the system operates. At higher flow rates within the operating range, such as flow rates approaching 14 ml/minute as described previously, the bubble may travel more rapidly through the fluidic pathway, and the time delay may be shorter to ensure that valve actuation occurs before the bubble progresses beyond the bubble trap cavity. At lower flow rates within the operating range, such as flow rates approaching 6 ml/minute, the bubble may travel more slowly through the fluidic pathway, and the time delay may be longer to allow the bubble to reach an appropriate position for effective redirection.

The time delay may allow the system to capture bubbles before the bubbles progress beyond the bubble trap cavity. By delaying valve actuation until the bubble has traveled to a position proximal to the bubble trap cavity, the system may ensure that the altered flow pattern resulting from valve actuation directs the bubble into the bubble trap cavity rather than allowing the bubble to continue toward the flow cell. The time delay may be controlled by a controller that receives the detection signal from the optical fluid sensor and initiates actuation of the first valve after the predetermined delay period has elapsed. The controller may store time delay values corresponding to different flow rates or operating conditions, and the controller may select an appropriate time delay value based on current system parameters.

In some cases, the time delay may be dynamically adjusted during spatial sequencing operations based on feedback from the optical fluid sensor or other system sensors. The system may monitor bubble detection events and valve actuation outcomes to refine the time delay for subsequent bubble removal operations. The millisecond time scale time delay may provide sufficient temporal resolution to acco mmodate variations in bubble velocity, bubble size, or fluid flow conditions that may occur during spatial sequencing operations.

The system configured to remove a bubble from a fluidic pathway of a spatial sequencing system operates through coordinated interaction between the fluidic pathway, the bubble trap cavity, the optical fluid sensor, and the first and second valves. The coordinated operation of these components provides bubble detection, bubble capture, and bubble removal functions that prevent bubbles from reaching the flow cell where spatial sequencing reactions occur.

During normal operation of the spatial sequencing system, fluid flows through the fluidic pathway from the one or more reagent or buffer input pathways toward the output fluidic pathway configured to direct fluid toward the flow cell. The fluid may include reagents, buffers, wash solutions, or other fluids used during spatial sequencing operations. As fluid flows through the fluidic pathway, the optical fluid sensor monitors the fluid for the presence of bubbles. The optical fluid sensor, which may be positioned along an input fluidic pathway upstream of the bubble trap cavity or adjacent the bubble trap cavity, continuously or periodically samples the fluid passing through the detection region to identify bubbles that may have entered the fluidic pathway during reagent loading, valve switching, or other fluidic operations.

When the optical fluid sensor detects the presence of a bubble in or near the bubble trap cavity, the optical fluid sensor generates a detection signal. The detection signal may be transmitted to a controller or directly to the first valve and the second valve to initiate the bubble removal sequence. The detection signal indicates that a bubble has been identified within the fluidic pathway and that valve actuation is warranted to prevent the bubble from progressing toward the flow cell.

Upon receiving the detection signal, the system initiates actuation of the first valve coupled to the fluidic pathway. The actuation of the first valve may occur after a time delay, which may be on a millisecond time scale, to allow the bubble to travel to a position where valve actuation provides effective redirection of the bubble toward the bubble trap cavity. The first valve transitions from a first configuration to a second configuration in response to the detection signal. In the second configuration, the first valve redirects fluid flow within the fluidic pathway such that the bubble is prevented from further progressing along the fluid pathway toward the flow cell. The redirection of fluid flow alters the flow pattern within the fluidic pathway, creating conditions that cause the bubble to migrate into the bubble trap cavity.

The bubble migrates into the bubble trap cavity due to the density differential between air and liquid in the fluidic pathway. The buoyancy force acting on the bubble causes the bubble to rise toward the vertical passageway of the bubble trap cavity. The ramped passageway of the bubble trap cavity, where present, facilitates bubble migration by providing an inclined path along which the bubble can travel toward the vertical passageway. The bubble enters the vertical passageway and rises into the globular chamber of the bubble trap cavity, where the bubble is retained. The geometry of the bubble trap cavity, including the spherical shape of the globular chamber and the chamfered upper portion where present, promotes bubble coalescence and accumulation within the globular chamber.

While the bubble is retained within the bubble trap cavity, the system activates the second valve to divert the bubble from the bubble trap cavity toward the waste stream pathway.

The optical fluid sensor may trigger actuation of the second valve as part of the coordinated bubble removal sequence. The second valve transitions from a closed state to an open state, establishing fluid co mmunication between the bubble trap cavity and the waste fluidic pathway. The open second valve provides a flow path through which the bubble accumulated within the globular chamber can be carried into the waste fluidic pathway. Fluid flow through the system may carry the bubble from the bubble trap cavity through the open second valve and into the waste fluidic pathway, where the bubble is directed toward a waste collection reservoir or waste outlet.

The coordinated actuation of the first valve and the second valve may occur sequentially or simultaneously depending on the system configuration. In some cases, the first valve may be actuated before the second valve to allow the bubble to migrate into the bubble trap cavity and accumulate within the globular chamber prior to diversion to the waste stream. In some cases, the first valve and the second valve may be actuated simultaneously to provide rapid bubble removal from the fluidic pathway. The timing of valve actuation may be controlled by a controller that coordinates the operation of the first valve and the second valve based on the detection signal from the optical fluid sensor and predetermined timing parameters.

After the bubble has been diverted to the waste stream pathway, the system may return to normal operation. The first valve may transition from the second configuration back to the first configuration, restoring normal fluid flow through the fluidic pathway toward the output fluidic pathway and the flow cell. The second valve may transition from the open state back to the closed state, terminating fluid co mmunication between the bubble trap cavity and the waste fluidic pathway. The optical fluid sensor may continue to monitor the fluid flowing through the fluidic pathway for the presence of additional bubbles, and the bubble removal sequence may be repeated as warranted when subsequent bubbles are detected.

The interaction between the fluidic pathway, the bubble trap cavity, the optical fluid sensor, and the first and second valves provides a coordinated bubble removal function that operates during spatial sequencing operations. The optical fluid sensor provides real-time detection of bubbles within the fluidic pathway, enabling the system to respond to bubble presence as bubbles occur. The first valve provides flow redirection capability that prevents detected bubbles from progressing toward the flow cell and causes bubbles to migrate into the bubble trap cavity. The bubble trap cavity provides a capture and retention region where bubbles accumulate until diversion to the waste stream. The second valve provides a diversion pathway through which accumulated bubbles are removed from the system via the waste fluidic pathway.

The coordinated operation of the system components may prevent bubble interference with sequencing operations at the flow cell. Bubbles that reach the flow cell may interfere with imaging operations by creating optical artifacts, may disrupt reagent delivery by blocking fluid channels, or may affect the accuracy of spatial sequencing results. By detecting bubbles upstream of the flow cell and diverting the bubbles to the waste stream pathway, the system may provide a bubble-free fluid stream to the flow cell during spatial sequencing operations. The system may operate at flow rates of 6 to 14 ml/minute while maintaining effective bubble detection and removal, acco mmodating the fluid delivery requirements of spatial sequencing applications.

### EXAMPLES

### Example 1. Microfluidic Device with Reduced Bubble Formation

Fluidic systems in biomedical devices, including sequencing and spatial analysis platforms, are susceptible to bubble formation, which can adversely affect system performance. Bubbles originating from upstream fluidic pathways can migrate into critical regions such as optical detection zones or biochemical sensing areas, where they may become temporarily or permanently trapped. The presence or movement of bubbles during detection can disrupt signal acquisition, leading to compromised data integrity.

In spatial sequencing applications, such as the G4X™ platform of Singular Genomics, bubble entrapment within tissue samples or on critical surfaces can introduce regions of reduced or absent detection, thereby diminishing data resolution and fidelity. Conventional bubble removal strategies often involve extensive flushing of the fluidic path to dislodge entrapped air; however, such approaches present several limitations. Flushing may require excessive and unpredictable fluid volumes, necessitate flow rates or pressure adjustments that exceed the operational constraints of the system, and inadvertently introduce additional bubbles from upstream components. Consequently, these methods are inefficient and do not address the fundamental cause of bubble formation within the fluidic architecture.

Furthermore, increased fluidic or reagent demands can impact reagent cartridge design and elevate operational costs. Implementing a real-time corrective response to bubble-induced data loss is also challenging due to the latency associated with image processing, making i mmediate recovery infeasible in certain scenarios. Alternative strategies, such as membrane-based bubble traps, present their own challenges, including manufacturing complexities, the requirement for additional vacuum systems, and susceptibility to biofouling, which can impair long-term performance. Passive bubble separation methods, such as de-bubblers, are often bulky, require significant priming volumes, and are incompatible with microfluidic networks or low-volume dosing applications.

To address these limitations, a novel approach is described herein. For example, the methods and devices provide inline bubble removal, preventing the ingress of bubbles into critical detection regions before they can cause disruptions. Unlike existing methods, this solution is fabricated using robust and scalable manufacturing techniques and integrates seamlessly within the fluidic path. The described method offers several key advantages, including minimal priming requirements, elimination of vacuum-assisted extraction, a compact footprint compatible with microfluidic architectures, and compatibility with a broad range of flow rates and pressure-driven fluidic systems. Additionally, the system can incorporate active bubble siphoning through optical sensing, enabling dynamic, real-time control of bubble removal, thereby enhancing fluidic stability and data reliability.

In many fluidic systems, including those employed in sequencing and spatial analysis platforms, diffusion-bonded manifolds are utilized for fluid handling, mixing, and controlled transport of liquids, reagents, and buffers. These manifolds typically incorporate valves to regulate flow and define specific fluidic pathways. The present invention introduces a specialized geometric design within the diffusion-bonded manifold that enables the efficient trapping and removal of bubbles. In embodiments, this approach is further enhanced by high dynamic-range optical fluid sensing, which detects the presence of air within the manifold and facilitates precise, real-time valve actuation to extract bubbles with minimal fluid waste.

The manifold geometry is specifically designed to facilitate bubble entrapment and removal through a multi-faceted approach. A designated cavity, referred to as the “bubble trap,” is strategically positioned within the manifold to leverage the natural buoyancy of bubbles, allowing them to migrate into the trap due to the density differential between air and liquid. This cavity is placed in close proximity to an optical fluid sensor capable of detecting air in the fluid stream. When a bubble is identified, the optical sensor triggers a rapid response sequence. After a short delay (e.g., on the millisecond timescale), the bubble rises fully into the designated trap, and the system initiates a series of brief, precisely timed valve actuations.

During this process, the active fluidic path leading to the flow cell is momentarily redirected, preventing the bubble from progressing further within the system. Simultaneously, a secondary valve connected to the bubble trap is activated, efficiently diverting the bubble into a waste stream. This targeted removal mechanism ensures that only the trapped air is extracted, thereby preserving the integrity of the fluidic system while minimizing reagent and buffer consumption. By integrating specialized geometry with real-time optical sensing and dynamic valve control, this invention offers a highly efficient, low-waste solution for mitigating bubble-related disruptions in microfluidic and sequencing applications.

### Example 2. Geometric Optimization for Bubble Trapping and Removal

A series of fluidic channel geometries were systematically designed and tested to optimize bubble trapping efficiency within the diffusion-bonded manifold. The initial phase of testing evaluated eight different configurations, focusing on variations in vertical channel alignment and ramp dimensions:

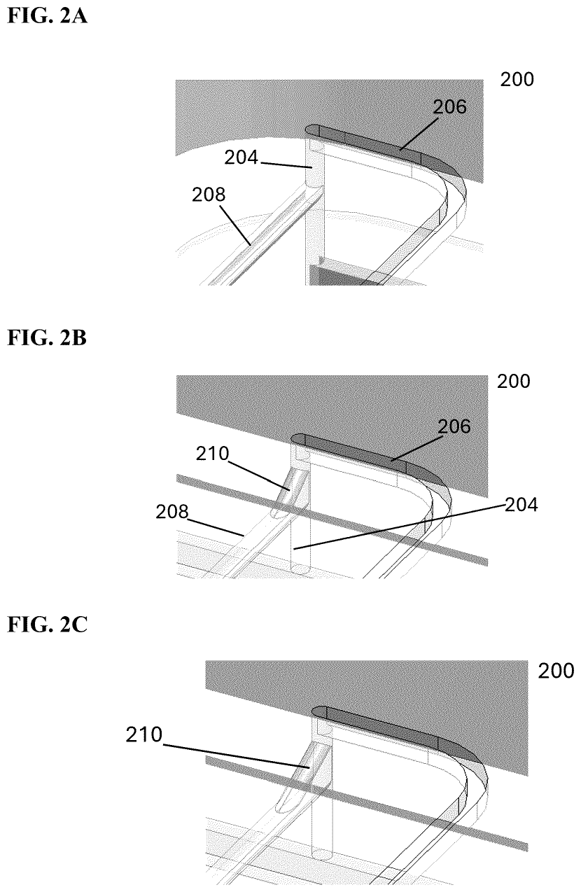

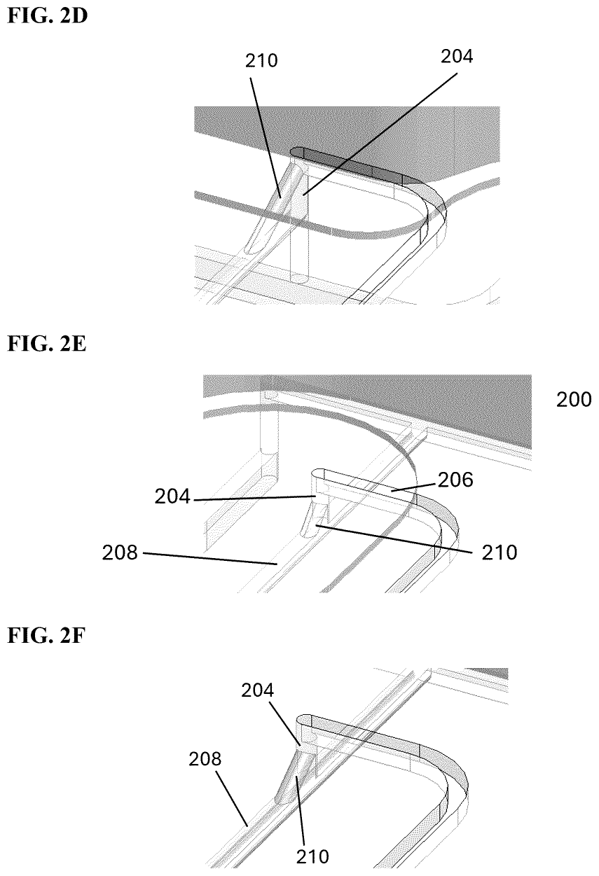

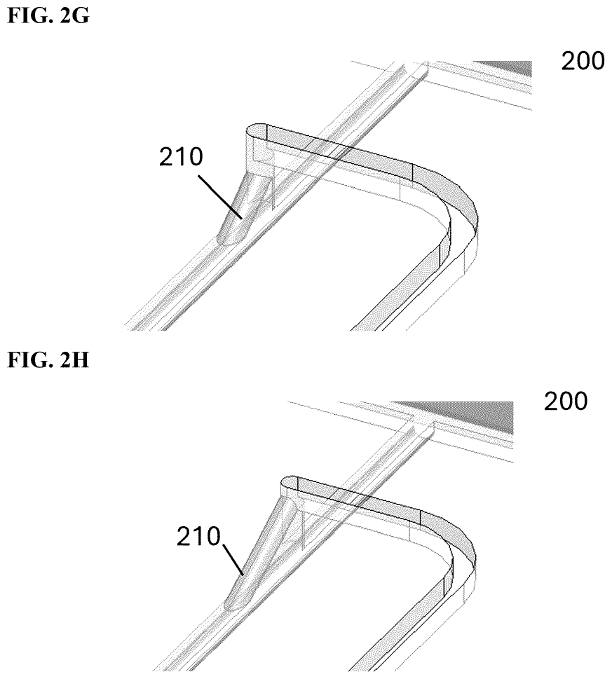

Straight vertical channel, no ramp (FIG. 2A.) FIG. 2A shows an example bubble trap assembly 200 formed of one or more fluid channels through which fluid can flow. The fluid channels include a vertical channel 204 fluidly connected at an upper region to a fluid channel 206 having an optional curved portion. A fluid channel 208 fluidly co mmunicates with the vertical channel 204 such as along the length of the vertical channel 204.

Straight vertical channel, 1.5×1 mm ramp (FIG. 2B.) FIG. 2B shows an example bubble trap assembly 200 formed of one or more fluid channels through which fluid can flow. The fluid channels include a vertical channel 204 fluidly connected at an upper region to a fluid channel 206 having a curved portion. A fluid channel 208 fluidly co mmunicates with the vertical channel 204 such as along the length of the vertical channel 204. A ramped fluid channel 210 fluidly connects the vertical channel 204 and the fluid channel 208. The ramped channel 204 extends along a long axis that is non-vertical with the vertical being defined by a long axis of the vertical channel 204.

Straight vertical channel, 2.25×1 mm ramp (FIG. 2C.) FIG. 2C shows an example bubble trap assembly 200 similar to assembly shown in FIG. 2B but having different dimensions in that the ramped channel 210 is a different length.

Straight vertical channel, 3×1.5 mm ramp (FIG. 2D.) FIG. 2D shows an example bubble trap assembly 200 similar to assembly shown in FIG. 2B but having different dimensions in that the ramped channel 210 is a different length and the vertical channel 204 is also a different length.

Offset vertical channel, 1×1 mm ramp (FIG. 2E.) FIG. 2E shows an example bubble trap assembly 200 formed of one or more fluid channels through which fluid can flow. The fluid channels include a vertical channel 204 fluidly connected at an upper region to a fluid channel 206 having an optional curved portion. A fluid channel 208 fluidly co mmunicates with the vertical channel 204 such as along the length of the vertical channel 204 such that the vertical channel 204 is offset from an end of the fluid channel 208. A ramped fluid channel 210 fluidly connects the vertical channel 204 and the fluid channel 208. The vertical channel

Offset vertical channel, 1.5×1 mm ramp (FIG. 2F.) FIG. 2F shows an example bubble trap assembly 200 similar to assembly shown in FIG. 2E but having different dimensions in that the ramped channel 210 is a different length.

Offset vertical channel, 2.25×1 mm ramp (FIG. 2G.) FIG. 2F shows an example bubble trap assembly 200 similar to assembly shown in FIG. 2E but having different dimensions in that the ramped channel 210 is a different length.

Offset vertical channel, 3×1.5 mm ramp (FIG. 2H.) FIG. 2H shows an example bubble trap assembly 200 similar to assembly shown in FIG. 2E but having different dimensions in that the ramped channel 210 is a different length.

Experimental results from these geometries indicated that the straight vertical channel exhibited superior bubble trapping performance compared to the offset vertical channel. However, seeking further optimization, a second iteration of eight refined geometries incorporating additional design modifications, such as ball-end bottom traps and varied lead-in features:

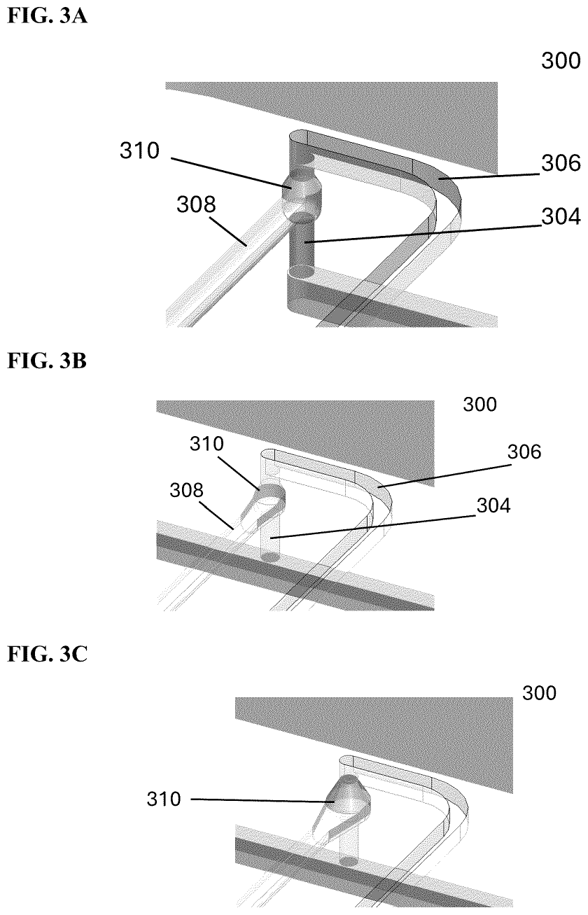

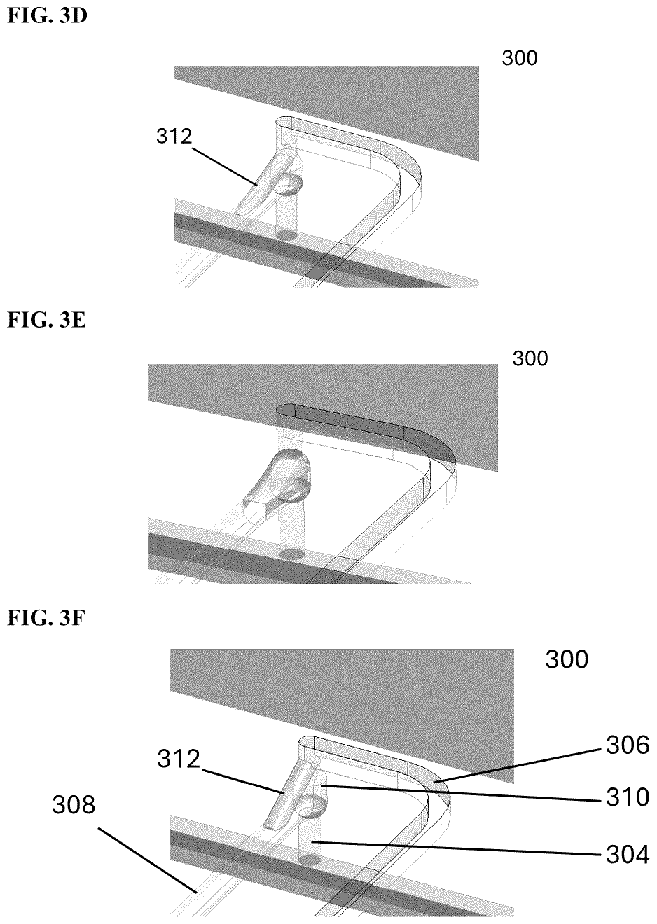

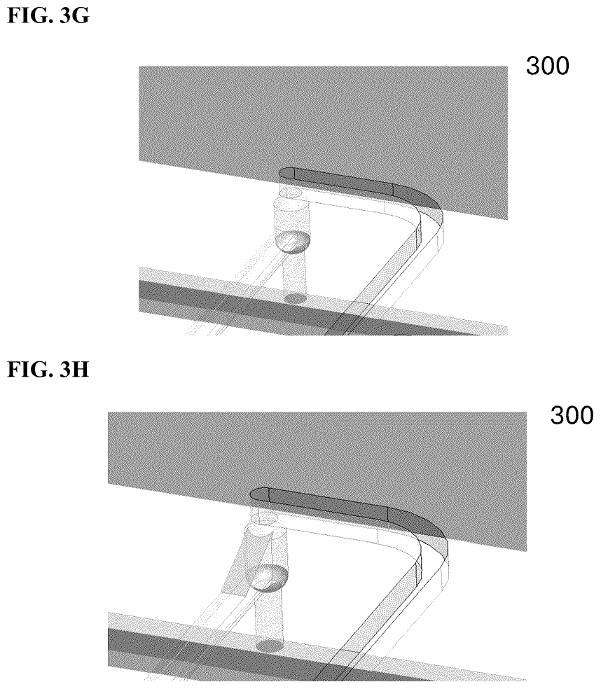

Ball-end bottom, 1 mm diameter trap, 60° chamfered top (FIG. 3A.) FIG. 3A shows an example bubble trap assembly 300 formed of one or more fluid channels through which fluid can flow. The fluid channels include a vertical channel 304 fluidly connected at an upper region to a fluid channel 306 having an optional curved portion. A fluid channel 308 fluidly co mmunicates with the vertical channel 304 such as along the length of the vertical channel 304. A bubble trap cavity 310 is positioned at a juncture between the vertical channel 304 and the fluid channel 308. The bubble trap cavity 310 has a chamfered region such as an upper end region.

Ball-end bottom, teardrop lead-in, 1 mm trap diameter, 60° chamfered top (FIG. 3B.) FIG. 3B shows an example bubble trap assembly 300 formed of one or more fluid channels through which fluid can flow. The fluid channels include a vertical channel 304 fluidly connected at an upper region to a fluid channel 306 having an optional curved portion. A fluid channel 308 fluidly co mmunicates with the vertical channel 304 such as along the length of the vertical channel 304. A bubble trap cavity 310 is positioned at a juncture between the vertical channel 304 and the fluid channel 308. The bubble trap cavity 310 has ball shaped bottom region and a teardrop-shaped region that leads into the bubble trap cavity 310.

Ball-end bottom, large teardrop lead-in, 1.5 mm trap diameter, 60° chamfered top (FIG. 3C.) FIG. 3C shows an example bubble trap assembly 300 similar to assembly shown in FIG. 3B wherein the bubble trap cavity310 has a larger tear drop lead-in region.

Ball-end bottom, 2×1 mm ball-end ramp, 1 mm trap diameter, 60° chamfered top (FIG. 3D.) FIG. 3D shows an example bubble trap assembly 300 similar to assembly shown in FIG. 3A wherein the assembly further includes a ramped fluid channel 312.

Ball-end bottom, interpolated ramp, 1 mm trap diameter (FIG. 3E.) FIG. 3E shows an example bubble trap assembly 300 similar to assembly shown in FIG. 3D wherein the assembly further includes a ramped fluid channel 312 that is interpolated with the bubble trap cavity.

Ball-end bottom, 2×1 mm ball-end ramp, 1 mm trap diameter, 60° chamfered top (FIG. 3F.). FIG. 3F shows an example bubble trap assembly 300 formed of one or more fluid channels through which fluid can flow. The fluid channels include a vertical channel 304 fluidly connected at an upper region to a fluid channel 306 having a curved portion. A fluid channel 308 fluidly co mmunicates with the vertical channel 304 such as along the length of the vertical channel 304. A bubble trap cavity 310 is positioned at a juncture between the vertical channel 304 and the fluid channel 308. The bubble trap cavity 310 has ball shaped bottom region. A ramped channel 312 fluidly connects the fluid channel 306 and the fluid channel 308.

Ball-end bottom, no ramp, 1 mm trap diameter, 60° chamfered top (FIG. 3G.) FIG. 3G shows an example bubble trap assembly 300 similar to assembly shown in FIG. 3F wherein the assembly does not have a ramped channel.

Ball-end bottom, 2×1 mm straight ramp, 1 mm trap diameter, 60° chamfered top (FIG. 3H.). FIG. 3G shows an example bubble trap assembly 300 similar to assembly shown in FIG. 3D but without a ball end on the ramped channel.

The results of this second round of testing demonstrated that geometry #14 (ball-end bottom, 2×1 mm ball-end ramp, 1 mm trap diameter, 60° chamfered top) was highly effective in both trapping and removing bubbles. This optimized design effectively leveraged the combined effects of buoyancy, channel geometry, and fluid dynamics to enhance bubble extraction efficiency, offering a significant improvement at bubble mitigation.

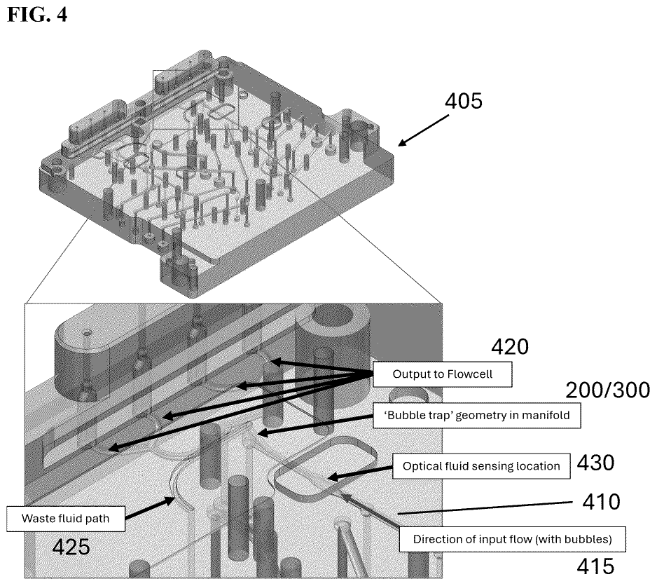

FIG. 4. shows a fluidic manifold 405 used for reagent delivery wherein the manifold 405 includes a bubble trap assembly such as any implementation of the bubble trap assemblies described herein. FIG. 4 includes an enlarged region showing example details of the bubble trap assembly 300 (which may also correspond to bubble trap assembly 200.) The bubble trap assembly 300 includes or is fluidly coupled to at least one fluidic pathway including for example an input fluidic pathway 410 (with a flow direction shown as 415), an output fluidic pathway 420 (flowing toward a coupled flowcell), and a waste fluidic pathway 425 for flow of waste. The input fluidic pathway 410 is in fluid co mmunication with the bubble trap assembly 300. An optical fluid sensor 430 is located proximal to the bubble trap cavity of the bubble trap assembly 300. The optical fluid sensor 430 is configured to detect a presence of a bubble in or near the bubble trap cavity. A first valve and a second valve are coupled to one or more of the fluidic pathways. Upon sensing the presence of the bubble, the optical fluid sensor 430 triggers actuation of the first valve to redirect fluid flow and prevent the bubble from further progressing along the output fluid pathway 420 toward the flow cell and further triggers the second valve to divert the bubble into a waste stream formed of the waste fluidic pathway 425.

The bubble trap cavity may a fluidic manifold formed at least partially of a ramped passageway that fluidly co mmunicates at an upper end with a globular chamber via a vertical passageway. The vertical passageway can be positioned offset from a center of the globular chamber. The vertical passageway is fluidly connected to the ramped passageway at a top end of the ramped passageway. The bubble trap cavity can comprise a spherical shape and can be at least partially chamfered. The bubble trap cavity can comprise a ramp having a spherical or ball end bottom.

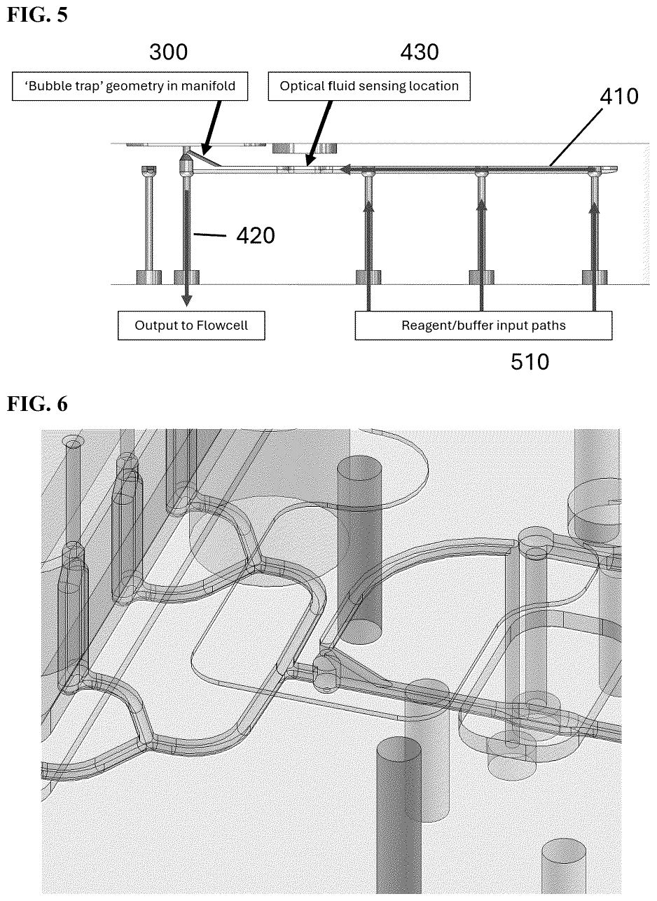

FIG. 5 shows a cross-sectional implementation of the bubble trap assembly 300 in a manifold. The input fluidic pathway 410 co mmunicates with the bubble trap assembly 300. One or more buffer and/or reagent fluidic pathways 510 co mmunicate with the input fluidic pathway 410. The buffer and/or reagent fluidic pathways 510 provide a fluid pathway for buffer and/or reagent to flow toward and into the bubble trap assembly 300 via the input fluidic pathway 410. The optical fluid sensor 430 is located proximal to the bubble trap cavity of the bubble trap assembly 300 such as along the input fluidic pathway 410. The output fluidic pathway 420 provides a pathway for fluid to flow out of the bubble trap assembly 300 toward a coupled flowcell.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further variations can be provided in addition to those set forth herein. For example, the implementations described above can be directed to various combinations and subcombinations of the disclosed features and/or combinations and subcombinations of several further features disclosed above. In addition, the logic flow(s) depicted in the accompanying figures and/or described herein do not necessarily require the particular order shown, or sequential order, to achieve desirable results. Other implementations may be within the scope of the following claims.

What is claimed is:

1. A system configured to remove a bubble from a fluidic pathway of a spatial sequencing system, the system comprising:
a fluidic pathway;
a bubble trap cavity in co mmunication with the fluidic pathway, the bubble trap cavity including a vertical passageway in co mmunication with the fluidic pathway;
an optical fluid sensor proximal to the bubble trap cavity, the optical fluid sensor configured to detect a presence of a bubble in or near the bubble trap cavity;
a first valve coupled to the fluidic pathway; and
a second valve coupled to the fluidic pathway;
wherein, upon sensing the presence of the bubble, the optical fluid sensor triggers actuation of the first valve to redirect fluid flow and prevent the bubble from further progressing along the fluid pathway and further triggers the second valve to divert the bubble into a waste stream.

2. The system of claim 1, wherein the bubble trap cavity comprises a fluidic manifold formed at least partially of a ramped passageway that fluidly co mmunicates at an upper end with a globular chamber via the vertical passageway.

3. The system of claim 2, wherein the vertical passageway is positioned along a center of the globular chamber.

4. The system of claim 2, wherein the vertical passageway is positioned offset from a center of the globular chamber.

5. The system of claim 1, wherein the bubble trap cavity comprises a spherical shape.

6. The system of claim 2, wherein at least a portion of the globular chamber is chamfered.

7. The system of claim 6, wherein an upper portion of the globular chamber is chamfered.

8. The system of claim 1, wherein the bubble trap cavity comprises a ramp having a spherical or ball end bottom.

9. The system of claim 8, wherein the ramp is 2×1 mm, and wherein the bubble trap cavity has a diameter of 1 mm and a 60 degree chamfered top.

10. The system of claim 1, wherein the vertical passageway is fluidly connected to a ramped passageway at a top end of the ramped passageway.

11. A method of removing a bubble from a fluidic pathway of a spatial sequencing system, the method comprising:
identifying presence of a bubble near a bubble trap cavity of the fluidic pathway;
actuating a first valve coupled to the fluidic pathway to cause the bubble to migrate into the bubble trap cavity;
redirecting fluid through the fluidic pathway such that the bubble is prevented from moving toward a flow cell; and
activating a second valve to divert the bubble from the bubble trap cavity toward a waste stream pathway.

12. The method of claim 11, wherein the bubble trap cavity comprises a fluidic manifold formed at least partially of a ramped passageway that fluidly co mmunicates with a globular chamber.

13. The method of claim 12, wherein the globular chamber is spherical.

14. The method of claim 12, wherein a portion of the globular chamber is chamfered.

15. The method of claim 11, wherein the presence of the bubble is identified using an optical fluid sensor.

16. The method of claim 15, wherein the optical fluid sensor is a high dynamic-range sensor.

17. The method of claim 15, wherein the optical fluid sensor is positioned adjacent the bubble trap cavity.

18. The method of claim 11, wherein the bubble migrates into the bubble trap cavity due to a density differential between air and liquid in the fluidic pathway.

19. The method of claim 11, wherein actuating the first valve occurs after a time delay.

20. The method of claim 19, wherein the time delay is on a millisecond time scale.

21. The method of claim 11, wherein the fluidic pathway comprises a diffusion-bonded manifold.

22. The method of claim 11, wherein the bubble migrates into the bubble trap cavity without flushing of the fluidic pathway.

23. The system of claim 1, wherein the fluidic pathway comprises a diffusion-bonded manifold.

24. The system of claim 1, further comprising an output fluidic pathway in fluid co mmunication with the bubble trap cavity, the output fluidic pathway configured to direct fluid toward a flow cell.

25. The system of claim 1, further comprising a waste fluidic pathway in fluid co mmunication with the bubble trap cavity, wherein the second valve is configured to divert the bubble into the waste fluidic pathway.

26. The system of claim 1, further comprising one or more reagent or buffer input pathways in fluid co mmunication with the fluidic pathway.

27. The system of claim 1, wherein the system is configured to operate at a flow rate of 6 to 14 ml/minute.

28. The method of claim 15, wherein the optical fluid sensor is positioned along an input fluidic pathway upstream of the bubble trap cavity.

29. The system of claim 2, wherein the bubble trap cavity further comprises a teardrop-shaped lead-in region.

30. The system of claim 2, wherein the fluidic pathway further comprises a curved fluid channel in fluid co mmunication with the vertical passageway.
